(19) United States
(12) Patent Application Publication
(10) Pub. No.: US 2026/0361387 A1
(43) Pub. Date: Nov. 12, 2026

(54) METHODS FOR CONFIGURATION, TRIGGERING, AND REPORTING ON DEMAND SIGNALS

(71) Applicant: InterDigital Patent Holdings, Inc., Wilmington, DE (US)

(72) Inventors: Haseeb Ur Rehman, Winnipeg (CA); Paul Marinier, Brossard (CA); Nazli Khan Beigi, Longueuil (CA); Loic Canonne-Velasquez, Dorval (CA); Ghyslain Pelletier, Montreal (CA); Aata El Hamss, Laval (CA); Moon IL Lee, Melville, NY (US); Tao Deng, New York, NY (US)

(73) Assignee: InterDigital Patent Holdings, Inc., Wilmington, DE (US)

(21) Appl. No.: 19/203,769

(22) Filed: May 9, 2025

(51) Int. Cl. H04B 7/06; H04L 5/00; H04L 41/16

(52) U.S. Cl. CPC H04B 7/06964; H04B 7/0626; H04L 5/0051; H04L 41/16

(57) ABSTRACT

A wireless transmit receive unit (WTRU) may receive configuration information that includes beam failure recovery (BFR) configuration information, channel state information (CSI) configuration information, a first reference signal (RS_resource set, and/or a second RS resource set. The WTRU may receive a (e.g., first) indication that at least one RS resource of the first RS resource set has been activated. The WTRU may send a message (e.g., a BFR message, a CSI message) to a base station based on the configuration information (e.g., BFR configuration information, CSI configuration information). The message (e.g., BFR message, CSI message) may include an indication of one or more measurements performed on the activated at least one RS resource. The message (e.g., BFR message, CSI message) may be sent using the second RS resource set. The WTRU may receive a (e.g., second) indication that the at least one RS resource has been deactivated.

### BACKGROUND

A wireless transmit/receive unit (WTRU) may transmit and/or receive a physical channel and/or reference signal according to at least one spatial domain filter. The term beam may be used to refer to a spatial domain filter.

The WTRU may transmit a physical channel and/or a signal using the same spatial domain filter as the spatial domain filter used for receiving an RS (e.g., such as a CSI-RS) and/or synchronization signal (SS) block. The WTRU transmission may be referred to as target, and/or the received RS and/or SS block may be referred to as reference and/or source. In examples, the WTRU may transmit the target physical channel and/or signal according to a spatial relation with a reference to such RS and/or SS block.

### SUMMARY

Embodiments described herein may include one or more methods to configure on demand signal(s). Configuration of reference signal (RS) resource set with activation and/or deactivation state(s) and/or one or more (e.g., multiple) transmission periodicities may be described herein.

Embodiments described herein may include one or more methods to trigger and/or request transmission and/or activation for on demand signal(s). Activation of RS resource(s) may be based on wireless transmit/receive unit (WTRU) request triggered by beam failure detection and/or one or more RS measurements.

Embodiments described herein may include one or more methods for WTRU feedback and/or report and/or response based on demand signal(s). Transmission of a beam failure recover (BFR) request and/or channel state information (CSI) report based on measurement(s) of on demand signal(s) may be described herein.

Embodiments described herein may include one or more methods to deactivate transmission of on demand signal(s). Deactivation of RS signal(s) based on transmission of a BFR request, CSI-report(s), and/or expiry of a timer may be described herein.

A WTRU may receive configuration information. The configuration information may include BFR configuration information, CSI configuration information, a first RS resource set, and/or a second RS resource set. At least one RS resource associated with the first RS resource set may be configured with an activation/deactivation state. The WTRU may receive a (e.g., first) indication that at least one RS resource of the first RS resource set has been activated (e.g., based on the condition that an RS resource configured with an activation/deactivation state may be associated with the configuration information). The WTRU may send a message (e.g., a BFR message, a CSI message) to a base station based on the configuration information (e.g., BFR configuration information, CSI configuration information). The message (e.g., BFR message, CSI message) may include an indication of one or more measurements performed on the activated at least one RS resource. The message (e.g., BFR message, CSI message) may be sent using the second RS resource set. The WTRU may receive a (e.g., second) indication that the at least one RS resource has been deactivated (e.g., based on the condition that an RS resource configured with an activation/deactivation state may be associated with the configuration information).

A WTRU may receive configuration information. The configuration information may include BFR configuration information, a first RS resource set, and/or a second RS resource set. The WTRU may receive a (e.g., first) indication that at least one RS resource of the first RS resource set has been activated (e.g., based on the condition that an RS resource configured with an activation/deactivation state may be associated with the configuration information). The WTRU may send a BFR message to a base station based on the BFR configuration information. The BFR message may include an indication of one or more measurements performed on the activated at least one RS resource. The BFR message may be sent using the second RS resource set. The WTRU may receive a (e.g., second) indication that the at least one RS resource has been deactivated (e.g., based on the condition that an RS resource configured with an activation/deactivation state may be associated with the configuration information).

A WTRU may receive configuration information. The configuration information may include CSI configuration information, a first RS resource set, and/or a second RS resource set. The WTRU may receive a (e.g., first) indication that at least one RS resource of the first RS resource set has been activated (e.g., based on the condition that an RS resource configured with an activation/deactivation state may be associated with the configuration information). The WTRU may send a CSI message to a base station based on the BFR configuration information. The CSI message may include an indication of one or more measurements performed on the activated at least one RS resource. The CSI message may be sent using the second RS resource set. The WTRU may receive a (e.g., second) indication that the at least one RS resource has been deactivated (e.g., based on the condition that an RS resource configured with an activation/deactivation state may be associated with the configuration information).

Activation of the at least one RS resource may include an increase in periodicity of transmission of the at least one RS resource. Deactivation of the at least one RS resource may include a decrease in periodicity of transmission of the at least one RS resource.

The first RS resource set may be and/or include one or more on-demand RS resources. For example, the whole set and/or a subset of RSs within the first RS resource set may be on-demand RS(s). The WTRU may activate the one or more on-demand RS resources to activate the one RS resources. The WTRU may deactivate the one or more on-demand RS resources to deactivate the at least one RS resource. The first RS resource set may be associated with one or more of a BFR configuration, a lower layer triggered mobility (LTM) configuration, a channel state information (CSI)-report configuration, and/or one or more artificial intelligence machine learning (AIML) sets. AIML sets may refer to measurement resource set(s) (e.g., input) and/or prediction resource set(s) (e.g., output), which may be applicable to one or more (e.g., any) AIML models.

The configuration information may include a RS request (RSR) configuration information. The WTRU may send a RSR request in accordance with the RSR configuration information. RSR configuration may include content to transmit (e.g., indication of which OD-RS to activate, how many to activate, etc.), a method of transmission (e.g., SR, PRACH, and/or UL-WUS, etc.) and/or one or more resources for transmission (e.g., which time and/or frequency resource(s). In response to the RSR request, for example, the WTRU may receive the (e.g., first) indication indicating activation of the at least one RS resource. The at least one RS resource may be activated based on the (e.g., first) indication.

The WTRU may receive the (e.g., second) indication to deactivate the at least one RS resource and/or receive a BFR response message. The at least one RS resource may be deactivated based on the second indication and/or the BFR response message.

The configuration may include an indication of a plurality of periodicities. To activate the at least one RS resource, for example, the WTRU may increase a periodicity from a first periodicity of the plurality of periodicities to a second periodicity of the plurality of periodicities or to a third periodicity of the plurality of periodicities. To deactivate the at least one RS resource, the WTRU may, for example, decrease the periodicity from the second periodicity or the third periodicity to the first periodicity or to a fourth periodicity of the plurality of periodicities.

The configuration information may include one or more thresholds associated with a beam-quality based determination, a time-based determination, and/or a prediction quality-based determination. The WTRU may activate and/or deactivate the at least one RS resource based on the one or more thresholds associated with the beam-quality based determination, the time-based determination, and/or the prediction quality-based determination.

The WTRU may determine a measurement value associated with each RS resource of the activated at least one RS resource. The WTRU may determine a subset of RS resources based on the measurement value when the measurement value is greater than a threshold of the one or more thresholds. The indication of the one or more measurements may include an indication of the subset of RS resources.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

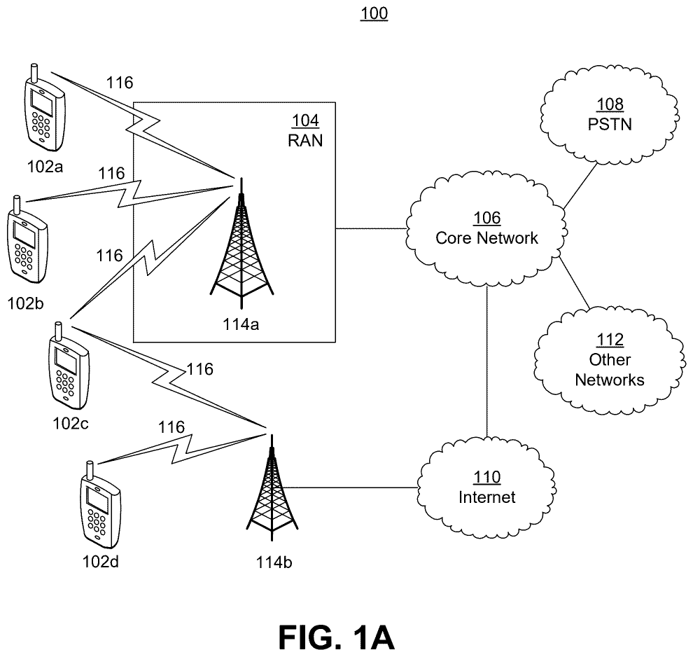

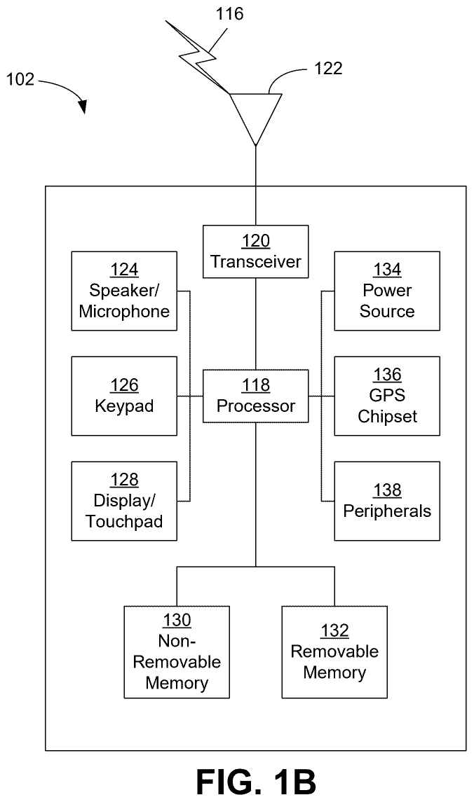

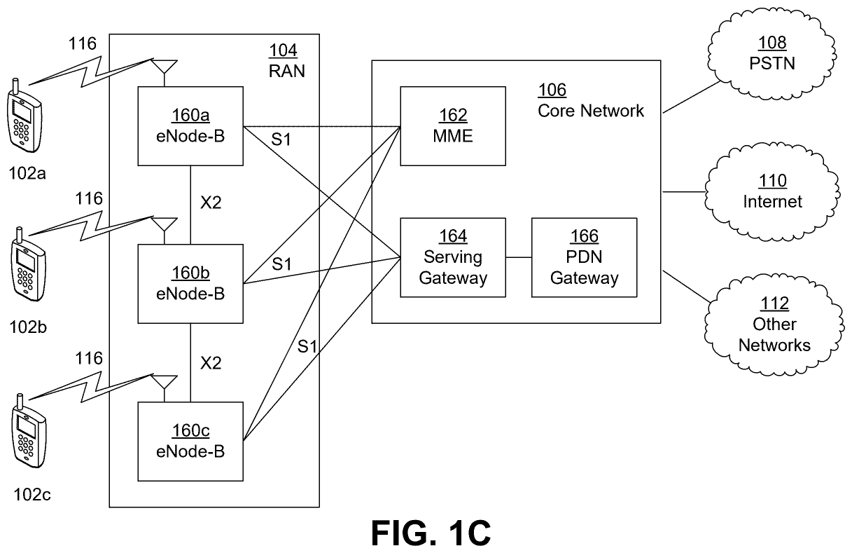

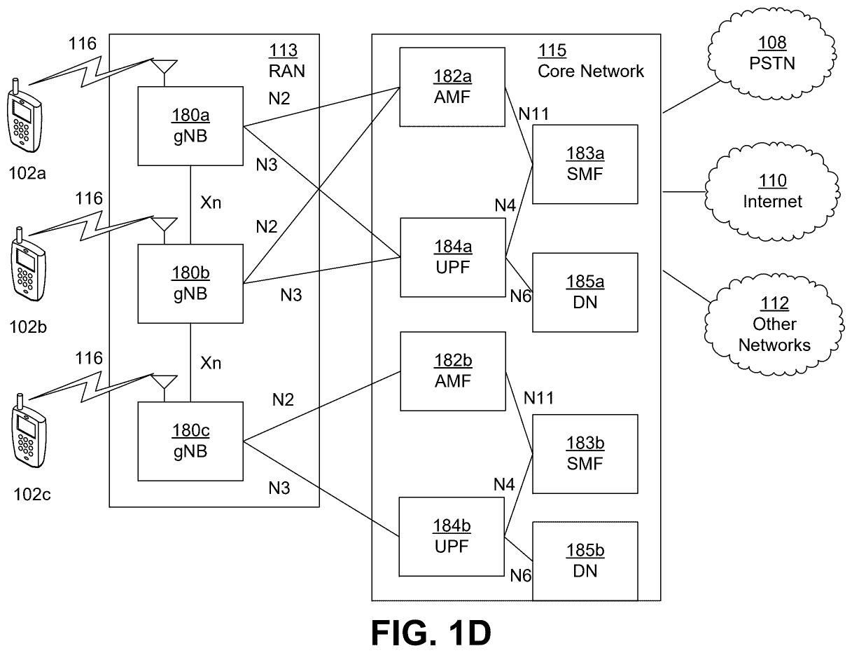

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

One or more (e.g., several) wireless transmit/receive unit (WTRU) procedures and/or functionalities may be based on always on signals (e.g., synchronization signal block (SSB)). These procedures may include beam failure detection, beam failure recovery, channel state information (CSI)-reporting, downlink (DL) synchronization, lower layer triggered mobility (LTM) reporting, and/or the like. One or more of the following may be (e.g., always) on signals: candidate RS resources associated with beam failure recovery, RSs associated with LTM candidate configuration(s), and/or RSs for DL synchronization signals. The (e.g., always) on RSs may be transmitted by the network regardless of whether a WTRU requires them or not (e.g., in the current moment). In examples, a WTRU may (e.g., rarely) use a procedure. For example, beam failure recovery may (e.g., rarely) be included (e.g., needed) for fixed movement and/or static devices (e.g., internet of things (IoT) and/or automated devices) by virtue of their limited movement and/or (e.g., appropriate) installation locations. In examples, it may be a waste of energy and/or resources to transmit always on signals. To save energy and/or network resources, there may be a procedure (e.g., in 6G) to dynamically activate signals based on WTRU requirement(s). Such signals may be referred to as on-demand signals.

One or more (e.g., current, network energy saving (NES) states, 5G) methods may include one or more (e.g., always) on signals (e.g., synchronization signal blocks (SSBs). One or more procedures that are based on (e.g., always) on signals may be configured with SSB RS(s). The transmission of on-demand SSB(s) may be network triggered (e.g., only) without WTRU input.

Embodiments described herein may address how to configure on demand signals. Embodiments described herein may address how to trigger and/or transmit a WTRU request to activate on demand signal(s). Embodiment described herein may address how to deactivate on demand signal(s).

A WTRU may receive configuration information. The configuration information may include BFR configuration information, a first RS resource set, and/or a second RS resource set. At least one RS resource associated with the first RS resource set may be configured with an activation/deactivation state. BFR configuration information may include information of candidate RS resource set(s) that the WTRU may measure to find a (e.g., new) beam. Additionally or alternatively, BFR configuration may include a configuration of one or more methods to transmit BFR message by the WTRU. The content of BFR message may be and/or include an indication of candidate RS associated with a (e.g., new) beam. The WTRU may receive a (e.g., first) indication that at least one RS resource of the first RS resource set has been activated (e.g., based on the configuration information). The WTRU may send a BFR message to a base station based on the BFR configuration information. The BFR message may include an indication of one or more measurements performed on the activated at least one RS resource. The BFR message may be sent using the second RS resource set. The WTRU may receive a (e.g., second) indication that the at least one RS resource has been deactivated (e.g., based on the condition that an RS resource configured with an activation/deactivation state may be associated with the configuration information).

A WTRU may receive configuration information. The configuration information may include CSI configuration information, a first RS resource set, and/or a second RS resource set. At least one RS resource associated with the first RS resource set may be configured with an activation/deactivation state. The configuration information of CSI report may include one or more resources for CSI-report transmission and/or associated RS resource set(s) on which the WTRU may perform RS measurement(s). The content of CSI report may be and/or include one or more WTRU measurements of RS resource set(s) configured with the CSI report. The WTRU may receive a (e.g., first) indication that at least one RS resource of the first RS resource set has been activated (e.g., based on the configuration information). The WTRU may send a CSI message to a base station based on the BFR configuration information. The CSI message may include an indication of one or more measurements performed on the activated at least one RS resource. The CSI message may be sent using the second RS resource set. The WTRU may receive a (e.g., second) indication that the at least one RS resource has been deactivated (e.g., based on the condition that an RS resource configured with an activation/deactivation state may be associated with the configuration information).

A WTRU may receive configuration information. The configuration information may include BFR configuration information, CSI configuration information, a first RS resource set, and/or a second RS resource set. At least one RS resource associated with the first RS resource set may be configured with an activation/deactivation state. BFR configuration information may include information of candidate RS resource set(s) that the WTRU may measure to find a (e.g., new) beam. Additionally or alternatively, BFR configuration may include a configuration of one or more methods to transmit BFR message by the WTRU. The content of BFR message may be and/or include an indication of candidate RS associated with a (E.g., new) beam. The configuration information of CSI report may include one or more resources for CSI-report transmission and/or associated RS resource set(s) on which the WTRU may perform RS measurement(s). The content of CSI report may be and/or include one or more WTRU measurements of RS resource set(s) configured with the CSI report. BFR candidate RS resource set(s) and/or CSI report RS resource set(s) may be associated with an OD-RS set. A WTRU may receive a configuration of a first RS resource set (e.g., on demand RS set), which may be associated with one or more beam failure recover (BFR) configurations, lower layer triggered mobility (LTM) candidate(s), and/or CSI report(s). The RSs may be activated based on CSI-report(s) and/or transmission of a RS request from a WTRU. The WTRU may measure one or more activated RSs associated with the first (e.g., RS) resource set. The WTRU may transmit a BFR request and/or a CSI-report. The first RS resource set may be associated with one or more of a BFR configuration, a lower layer triggered mobility (LTM) configuration, a channel state information (CSI)-report configuration, and/or one or more artificial intelligence machine learning (AIML) sets. AIML sets may refer to measurement resource set(s) (e.g., input) and/or prediction resource set(s) (e.g., output), which may be applicable to one or more (e.g., any) AIML models.

A WTRU may receive configuration information. The configuration information may include one or more of the following. The configuration information may include a (e.g., first) RS resource set configured with an activation state and/or a plurality of transmission periodicities. The (e.g., first) RS resource set may be associated with BFR configuration(s), LTM configuration(s), CSI-report(s), and/or artificial intelligence machine learning (AIML) set(s). AIML sets may refer to measurement resource set(s) (e.g., input) and/or prediction resource set(s) (e.g., output), which may be applicable to one or more (e.g., any) AIML models. The configuration information may include a (e.g., second) RS resource set. The (e.g., second) RS resource may be associated with one or more transmission resources for one or more WTRU requests. The configuration information may include one or more thresholds (e.g., beam quality threshold(s), time threshold(s), prediction quality threshold(s). The configuration information may include report and/or request configuration information: RS request (RSR) configuration (e.g., via scheduling request (SR), uplink (UL)—wake up signal (WUS), physical random access channel (PRACH), and/or the like); and/or CSI-report configuration information (e.g., associated with the first RS resource set). The configuration information may include a RS request (RSR) configuration information. The WTRU may send a RSR request in accordance with the RSR configuration information. RSR configuration may include content to transmit (e.g., indication of which OD-RS to activate, how many to activate, etc.), a method of transmission (e.g., SR, PRACH, and/or UL-WUS, etc.) and/or one or more resources for transmission (e.g., which time and/or frequency resource(s)). In response to the RSR request, for example, the WTRU may receive the (e.g., first) indication indicating activation of the at least one RS resource. The at least one RS resource may be activated based on the (e.g., first) indication. The configuration may include an indication of a plurality of periodicities. The configuration information may include one or more thresholds associated with a beam-quality based determination, a time-based determination, and/or a prediction quality-based determination.

The WTRU may receive a (e.g., first) indication that at least one RS resource of the first RS resource set has been activated. Activation of the at least one RS resource may include an increase in periodicity of transmission of the at least one RS resource. The first RS resource set may be and/or include one or more on-demand RS resources. For example, the whole set and/or a subset of RSs within the first RS resource set may be on-demand RS(s). The WTRU may activate the one or more on-demand RS resources to activate the one RS resources. The WTRU may receive an indication indicating activation and/or increase in transmission periodicity (e.g., based on WTRU transmission of CSI-report) and/or one or more requests (e.g., triggered based on beam failure detection) to activate and/or increase transmission periodicity of RSs associated with the (e.g., first) RS resource set by transmitting an RSR. The WTRU may receive an indication confirming activation and/or increase in transmission periodicity of RSs associated with the (e.g., first) RS resource set based on, for example the transmission of RSR. To activate the at least one RS resource, for example, the WTRU may increase a periodicity from a first periodicity of the plurality of periodicities to a second periodicity of the plurality of periodicities or to a third periodicity of the plurality of periodicities. The WTRU may activate and/or deactivate the at least one RS resource based on the one or more thresholds associated with the beam-quality based determination, the time-based determination, and/or the prediction quality-based determination.

The WTRU may measure activated RSs associated with the first RS resource set. For example, the WTRU may determine a measurement value associated with each RS resource of the activated at least one RS resource. The WTRU may determine a subset of RS resources based on the measurement value based on when and/or whether the measurement value is greater than a threshold of the one or more thresholds. The WTRU may send a message (e.g., a BFR message, a CSI message) to a base station based on the configuration information (e.g., BFR configuration information, CSI configuration information). The message (e.g., BFR message, CSI message) may include an indication of one or more measurements performed on the activated at least one RS resource. The indication of the one or more measurements may include an indication of the subset of RS resources. The message (e.g., BFR message, CSI message) may be sent using the second RS resource set. The WTRU may perform one or more of the following, for example, based on the measurement(s). The WTRU may transmit a beam failure recover request (e.g., via medium access control (MAC) control element (CE) BFR and/or PRACH). The WTRU may transmit a CSI report.

The WTRU may receive a (e.g., second) indication that the at least one RS resource has been deactivated. Deactivation of the at least one RS resource may include a decrease in periodicity of transmission of the at least one RS resource. The WTRU may receive the (e.g., second) indication to deactivate the at least one RS resource and/or receive a BFR response message. For example, reception of BFR response may indicate (e.g., imply) a successfully completed BFR procedure (e.g., the reception of BFR response may be and/or include indication). Additionally or alternatively, the BFR response's payload (e.g., msg2) may include an indication of one or more RS(s) to deactivate (e.g., via MAC-CE and/or DCI). The at least one RS resource may be deactivated based on the second indication and/or the BFR response message. The WTRU may deactivate the one or more on-demand RS resources to deactivate the at least one RS resource. The WTRU may receive an indication indicating deactivation and/or a decrease in transmission periodicity and/or may determine deactivated state and/or decreased transmission periodicity of the RSs associated with the (e.g., first) RS resource based on one or more of the following. The WTRU may receive an indication indicating deactivation and/or a decrease in transmission periodicity and/or may determine deactivated state and/or decreased transmission periodicity of the RSs associated with the (e.g., first) RS resource based on transmission of a BFR request, reception of BFR response (e.g., msg2), and/or transmission of CSI-report (e.g., LTM CSI report, aperiodic CSI report, AIML CSI report, etc.). The WTRU may receive an indication indicating deactivation and/or a decrease in transmission periodicity and/or may determine deactivated state and/or decreased transmission periodicity of the RSs associated with the (e.g., first) RS resource based on time-based deactivation (e.g., X symbols, slots/msec based on activation of RSs). To deactivate the at least one RS resource, the WTRU may, for example, decrease the periodicity from the second periodicity or the third periodicity to the first periodicity or to a fourth periodicity of the plurality of periodicities. The WTRU may activate and/or deactivate the at least one RS resource based on the one or more thresholds associated with the beam-quality based determination, the time-based determination, and/or the prediction quality-based determination. Activation of an RS may refer to turning on transmission of RS (e.g., from WTRU perspective). For example, a WTRU (e.g., and/or WTRU's processor) may be configured to enable measurement of that RS and/or increase periodicity of RS. Deactivation of an RS may refer to turning off transmission of RS (e.g., from WTRU perspective). For example, a WTRU (e.g., and/or WTRU's processor) may be configured to disable measurement of that RS and/or decrease periodicity of RS.

Embodiments described herein may improve energy efficiency of the network, for example, by enabling the WTRU to assist in the network scheduling RSs (e.g., only) when required (e.g., instead of always on as in 5G).

Embodiments described herein may include one or aspects common to one or more (e.g., all) components. A and/or an and/or one or more similar phrase may be interpreted as one or more and/or at least one. One or more terms that end in the suffix s may be interpreted as one or more and/or at least one. The term may can be interpreted as may, for example.

AI may be broadly referred to as the behavior exhibited by machines that mimic cognitive functions to sense, reason, adapt, and/or act. An AI component may refer to the realization of behaviors and/or conformance to requirements by learning based on data, without explicit configuration of sequence of procedures of actions. Such AI component(s) may enable learning complex behaviors which might be difficult to specify and/or implement when using other (e.g., legacy) methods.

Machine learning (ML) may refer to the type of algorithm(s) that solve a problem based on learning through experience (e.g., data), without being explicitly programmed (e.g., configuring a set of rules). ML can be considered as a subset of AI. Different ML paradigms may be envisioned based on the nature of data and/or feedback available to the learning algorithm. In examples, a supervised learning approach may include learning a function that maps input to an output based on labeled training example, where each training example may be a pair including an input and its corresponding output. In examples, an unsupervised learning approach may include detecting patterns in the data with no pre-existing labels. In examples, a reinforcement learning approach may include performing sequence of actions in an environment to maximize the cumulative reward. In examples, it may be possible to apply ML algorithms using a combination and/or interpolation of the above-mentioned approaches. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may refer to a class of ML algorithms that employ artificial neural networks, specifically, Deep Neural Networks (DNNs), which were loosely inspired from biological systems. The DNNs may be a special class of ML models that are inspired by the human brain, where the input may be linearly transformed and/or may pass through non-linear activation function one or more (e.g., multiple) times. DNNs may include one or more (e.g., multiple) layers, where each layer may include linear transformation and/or a given non-linear activation function. The DNNs can be trained using the training data via back-propagation algorithm. DNNs may show state-of-the-art performance in one or more (e.g., a variety of) domains (e.g., speech, vision, natural language, wireless communication, etc.), and/or for one or more (e.g., various) ML settings (e.g., supervised, un-supervised, semi-supervised, etc.). The term AIML based methods and/or processing may refer to realization of behaviors and/or conformance to requirement(s) by learning based on data, without (e.g., explicit) configuration of sequence of steps of actions. Such methods may enable learning complex behaviors which might be difficult to specify and/or implement when using one or more other (e.g., legacy) methods.

A WTRU may transmit and/or receive a physical channel and/or reference signal according to at least one spatial domain filter. The term beam may be used to refer to a spatial domain filter.

The WTRU may transmit a physical channel and/or a signal using the same spatial domain filter as the spatial domain filter used for receiving an RS (e.g., such as a CSI-RS) and/or synchronization signal (SS) block. The WTRU transmission may be referred to as target, and/or the received RS and/or SS block may be referred to as reference and/or source. In examples, the WTRU may transmit the target physical channel and/or signal according to a spatial relation with a reference to such RS and/or SS block.

The WTRU may transmit a (e.g., first) physical channel and/or signal according to the same spatial domain filter as the spatial domain filter used for transmitting another (e.g., second) physical channel and/or signal. The first and/or second transmissions may be referred to as target and/or reference (e.g., source), respectively. In examples, the WTRU may transmit the first (e.g., target) physical channel and/or signal according to a spatial relation with a reference to the second (e.g., reference) physical channel and/or signal.

A spatial relation may be implicit, configured by radio resource control (RRC) and/or signaled by MAC CE and/or downlink control information (DCI). For example, a WTRU may (e.g., implicitly) transmit physical uplink shared channel (PUSCH) and/or demodulation reference signal (DM-RS) of PUSCH according to the same spatial domain filter as an SRS indicated by SRS resource set indicator (SRI) indicated in DCI and/or configured by RRC. In examples, a spatial relation may be configured by RRC for an SRI and/or signaled by MAC CE for a physical uplink control channel (PUCCH). Such spatial relation may (e.g., also) be referred to as a beam indication.

The WTRU may receive a first (e.g., target) downlink channel and/or signal according to the same spatial domain filter and/or spatial reception parameter as a second (e.g., reference) downlink channel and/or signal. For example, such association may exist between a physical channel such as physical downlink control channel and/or physical downlink shared channel and its respective DM-RS. At least when the first and/or second signal(s) are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS and/or SS block and a DM-RS by an index to a set of TCI states configured by RRC and/or signaled by MAC CE. Such indication may (e.g., also) be referred to as a beam indication.

A transmission and/or reception point (TRP) may be interchangeably used with one or more of a transmission point (TP), a reception point (RP), a radio remote head (RRH), a distributed antenna (DA), a base station (BS), a sector (e.g., of a base station), and/or a cell (e.g., a geographical cell area served by a BS). Multi-TRP may be interchangeably used with one or more of MTRP, M-TRP, and/or one or more (e.g., multiple) TRPs.

A WTRU may report a subset of CSI components, where CSI components may correspond to at least a CSI-RS resource indicator (CRI), a SSB rsource indicator (SSBRI), an indication of a panel used for reception at the WTRU (e.g., such as a panel identify and/or group identify), one or more measurements such as layer 1 (L1)-reference signal received power (RSRP), L1-signal to noise interference ratio (SINR) taken from SSB and/or CSI-RS (e.g., CRI-RSRP, CRI-SINR, ssb-index-RSRP, ssb-index-SINR, and/or one or more other channel state information such as, for example, rank indicator (RI), channel quality indicator (CQI), precoding matrix indicator (PMI), layer index (L1), and/or the like.

A WTRU may receive a synchronization signal and/or physical broadcast channel (SS/PBCH) block. The SS/PBCH block (SSB) may include a primary synchronization signal (PSS), a secondary synchronization signal (SSS), and/or a physical broadcast channel (PBCH). The WTRU may monitor, receive, and/or attempt to decode an SSB during initial access, initial synchronization, radio link monitoring (RLM), cell search, cell switching, and/or the like.

A WTRU may measure and/or report the CSI. The CSI for each connection mode may include and/or be configured with one or more of the following. CSI report configuration may include one or more of the following: CSI report quantity (e.g., CQI, RI, precoding matrix indicator (PMI), CRI, layer indicator (LI), etc.); a CSI-report type (e.g., aperiodic, semi-persistent, periodic); a CSI report codebook configuration (e.g., Type I, Type II, Type II port selection, etc.); and/or a CSI report frequency. CSI-RS may include one or more of the following CSI resource settings: non-zero power (NZP)-CSI-RS resource for channel measurement(s); NZP-CSI-RS resource for interference measurement(s); and/or CSI-interference measurement (IM) resource for interference measurement(s). NZP CSI-RS resources may include one or more of the following: a NZP CSI-RS resource ID; a periodicity and/or an offset; QCL information and/or a TCI-state; and/or resource mapping (e.g., a number of ports, density, a code division multiplexing (CDM) type, and/or the like).

A WTRU may indicate, determine, and/or be configured with one or more RSs. The WTRU may monitor, receive, and/or measure one or more parameters based on, for example, the respective RSs. For example, one or more of the following may apply. The following parameters may non-limiting examples of the parameters that may be included in RS measurement(s). One or more of these parameters may be included. One or more other parameters may be included.

The WTRU may monitor, receive, and/or measure SS-RSRP. SS-RSRP may be measured based on the synchronization signal(s) (e.g., DM-RS in PBCH and/or SSS). SS-RSRP may be referred to as the linear average over the power contribution of the resource elements (REs) that carry the respective synchronization signal. In measuring the RSRP, power scaling for the RSs may be included and/or required. If SS-RSRP is used for L1-RSRP, for example, the measurement may be accomplished based on CSI reference signals and/or the synchronization signal(s).

The WTRU may monitor, receive, and/or measure CSI-RSRP. CSI-RSRP may be measured based on the linear average over the power contribution of the REs that carry the respective CSI-RS. The CSI-RSRP measurement may be configured within measurement resource(s) for the configured CSI-RS occasion(s).

The WTRU may monitor, receive, and/or measure SS-SINR. SS-SINR may be measured based on the synchronization signals (e.g., DM-RS in PBCH and/or SSS). SS-SINR may be referred to as the linear average over the power contribution of the REs that carry the respective synchronization signal divided by the linear average of the noise and interference power contribution. If SS-SINR is used for L1-SINR, for example, the noise and interference power measurement may be accomplished based on resource(s) configured by higher layer(s).

The WTRU may monitor, receive, and/or measure CSI-SINR. CSI-SINR may be measured based on the linear average over the power contribution of the REs that carry the respective CSI-RS divided by the linear average of the noise and interference power contribution. If CSI-SINR is used for L1-SINR, for example, the noise and interference power measurement may be accomplished based on resources configured by higher layer(s). The noise and interference power may be measured based on the resources that carry the respective CSI-RS.

The WTRU may monitor, receive, and/or measure received signal strength indicator (RSSI). RSSI may be measured based on the average of the total power contribution in configured OFdM symbols and/or bandwidth. The power contribution may be received from one or more different resources (e.g., co-channel serving and/or non-serving cells, adjacent channel interference, thermal noise, and/or the like).

The WTRU may monitor, receive, and/or measure cross-layer interference (CLI)-RSSI. CLI-RSSI may be measured based on the average of the total power contribution in configured OFDM symbols of the configured time and/or frequency resources. The power contribution may be received from one or more different resources (e.g., CL), co-channel serving and/or non-serving cells, adjacent channel interference, thermal noise, and/or the like).

The WTRU may monitor, receive, and/or measure sounding reference signal (SRS)-RSRP. SRS-RSRP may be measured based on the linear average over the power contribution of the REs that carry the respective SRS.

A CSI report configuration (e.g., CSI-ReportConfigs) may be associated with a single bandwidth part (BWP) (e.g., indicated by BWP-Id). One or more of the following parameters may be configured: CSI-RS resource(s) and/or CSI-RS resource set(s) for channel and/or interference measurement(s); a CSI-RS report configuration type (e.g., periodic, semi-persistent, aperiodic); a CSI-RS transmission periodicity for periodic and/or semi-persistent CSI reports; CSI-RS transmission slot offset for periodic, semi-persistent, and/or aperiodic CSI reports; a CSI-RS transmission slot offset list for semi-persistent and/or aperiodic CSI reports; one or more time restrictions for channel and/or interference measurement(s); one or more thresholds and/or modes of calculation for the reporting quantity(ies) (e.g., CQI, RSRP, SINR, LI, RI, etc.); codebook configuration; group based beam reporting; a CQI table; subband size; non-PMI port indication; a port index; and/or the like.

A CSI-RS resource set (e.g., NZP-CSI-RS-ResourceSet) may include one or more CSI-RS resources (e.g., NZP-CSI-RS resource and/or CSI-ResourceConfig). A WTRU may be configured with one or more of the following in a CSI-RS resource: CSI-RS periodicity and/or slot offset for periodic and/or semi-persistent CSI-RS resources; CSI-RS resource mapping to define the number of CSI-RS ports, density, CDM-type, OFDM symbol, and/or subcarrier occupancy; a bandwidth part to which the configured CSI-RS may be allocation; and/or a reference to the TCI-state including the QCL source RS(s) and/or the corresponding QCL type(s).

A WTRU may be configured with one or more RS resource sets. The RS resource set configuration may include one or more of the following: RS resource set ID; one or more RS resources for the RS resource set; a repetition (e.g., on or off); aperiodic triggering offset (e.g., one of 0-6 slots); and/or tracking reference signal (TRS) information (e.g., true, not true).

A WTRU may be configured with one or more RS resources. The RS resource configuration may include one or more of the following: RS resource ID; resource mapping (e.g., REs in a physical resource block (PRB); a power control offset (e.g., one value of −8, . . . , 15); a power control offset with SS (e.g., −3 dB, 0 dB, 3 dB, 6 Db); a scrambling ID; a periodicity and/or offset; and/or QCL information (e.g., based on a TCI state).

RS may be interchangeably used with one or more of RS resource, RS resource set, RS port, and/or RS port group. RS may be interchangeably used with one or more of: SSB, CSI-RS, CRS, DM-RS, TRS, positioning RS (PRS), and/or phase tracking RS (PTRS). A RS may be interchangeably used with SRS, CSI-RS, DM-RS, PTRS, and/or SSB. A channel may be interchangeably used with physical downlink control channel (PDCCH), physical downlink shared channel (PDSCH), physical uplink control channel (PUCCH), physical uplink shared channel (PUSCH), PRACH, and/or the like.

A key performance indicator (KPI) may refer to one or more of the following: a signal quality (e.g., L1-RSRP, SINR, CQI, RSSI, RSRQ); a prediction performance (e.g., percentage of the top-1 genie-aided (e.g., strongest) beam(s) may be one of the Top-K predicted beam(s); a link quality (e.g., throughput, block error rate (BLER)); data distribution (e.g., mean and/or variance of measured and/or predicted beam measurement(s)); and/or RSRP (e.g., L1-RSRP) difference (e.g., the difference between measured and predicted RSRP of a beam).

A signal, channel, and/or message (e.g., as in downlink and/or uplink signal, channel, and/or message) may be used interchangeably herein. A RS resource set may be used interchangeably herein with a RS resource and/or a beam group. Beam reporting may be used interchangeably herein with CSI measurement(s), CSI reporting and/or beam measurement(s).

Embodiments described herein for beam resource(s) prediction may be used for beam resource(s) belonging to a single and/or one or more (e.g., multiple) cells as well as single and/or one or more (e.g., multiple) TRPs. CSI reporting may be interchangeably used with CSI measurement, beam reporting, and/or beam measurement.

Uplink wake up signal (UL-WUS) may refer to an uplink signal that may be transmitted by the WTRU to send an indication, request an uplink grant, request a downlink transmission, and/or report data. UL-WUS may refer to an existing UL signal and/or channel (e.g., SRS, PUCCH, PUSCH, and/or PRACH) and/or another (e.g., new) type of UL signal and/or channel, different than existing UL signals and/or channel(s).

A reference signal request (RSR) may be interchangeably used herein with a transmission (Tx) occasion request. An activation of an RS resource and/or RS resource set may refer to turning on transmission of an RS and/or RSs associated with an RS resource set, and/or increase the periodicity of a transmitted RS and/or RSs associated with an RS resource set. A deactivation of an RS resource and/or RS resource set may refer to turning off transmission of an RS and/or RSs associated with an RS resource set, and/or decrease in the periodicity of a transmitted RS and/or RSs associated with an RS resource set.

Embodiments described herein may include one or more methods to configure on demand signals. A WTRU may receive a configuration message (e.g., via RRC, MAC-CE, and/or DCI of one or more of the following.

A WTRU may receive a configuration message that includes configuration information associated with a first RS resource set associated with one or more RS resources. In examples, one or more RS resources associated with the first RS resource may be set associated with an activation and/or deactivation state parameter. The activation and/or deactivation state parameter may be configured within an RS resource and/or RS resource set configuration. For example, the configuration information may include a one-bit information element (IE) parameter inside an RS resource configuration indicating the state (e.g., activated and/or deactivated state of an RS). For example, the configuration information may include a bitmap IE parameter inside RS resource set configuration indicating state(s) of one or more RS(s) associated with the first RS resource set. In examples, a first bit value of the state parameter (e.g., 1) may indicate to the WTRU that the associated RS may be activated and/or transmitted by the gNB. In examples, a second value (e.g., 0) may indicate to the WTRU that the associated RS may be deactivated and/not transmitted by the gNB. In examples, the WTRU may receive configuration information of one or more RSs without one or more configuration parameter(s). For example, the WTRU may receive configuration information of one or more RSs without physical transmission parameter(s) (e.g., resource mapping, periodicity, and/or offset, etc.). In examples, the absence of one or more parameters associated with an RS resource configuration may indicate to the WTRU that an RS may not be transmitted and/or activated by the gNB. In examples, the first RS resource set may be configured with a plurality of transmission configurations. For example, the WTRU may be configured with a short and/or long transmission period of the RS(s) associated with the first RS resource set. For example, the long transmission period may be the default transmission period. For example, the short transmission period may be the default transmission period. In examples, the first RS resource set may be associated with one or more of the following configurations.

The first RS resource set may be associated with beam failure recovery configuration information. In examples, the first RS resource set may be configured as and/or associated with the candidate RS resource set inside beam failure recover configuration. In examples, a plurality of candidate RS resource set(s) may be associated with beam failure configuration, where one or more RS resource sets may have the same configuration property(ies) (e.g., activation and/or deactivation state and/or absence of configuration parameter(s) and/or the like) as the first RS resource set with different set of RS resource(s).

The first RS resource set may be associated with LTM candidate configuration information. In examples, the first RS resource set may be configured as and/or associated with the candidate RS resource set inside LTM candidate configuration (e.g., configuration information). In examples, the WTRU may be configured with a plurality of LTM candidate configuration(s), where one or more RS resource sets may be associated with an LTM candidate configuration may have the same configuration property(ies) as the first RS resource set and/or with different set of RS resource(s).

The first RS resource set may be associated with a CSI-report. In examples, the WTRU may be configured with an aperiodic, semi-persistent, and/or periodic CSI report associated with the first RS resource set.

The first RS resource set may be associated with beam adjustment(s). In examples, the WTRU may receive a configuration and/or indication (e.g., via RRC, MAC-CE, and/or DCI) to measure RS resource(s) associated with the first RS resource set for one or more beam management procedures (e.g., DL transmit and/or UL transmit and/or receiver beam adjustment).

The first RS resource set may be associated with an AIML resource set. In examples, the first RS resource set may be associated with an AIML measurement set and/or AIML prediction set.

In examples, the WTRU may receive a configuration message (e.g., via RRC, MAC-CE, and/or DCI) associated with a second RS resource set. In examples, the RSs associated with a second RS resource set may be configured without activation and/or deactivation state parameter(s). In examples, one or more transmission parameters associated with RS resources associated with the second resource set may be different than the RS resources associated with the first resource set. For example, the transmission periodicity of an RS resource associated with the second RS resource set may be longer than the periodicity of an RS resource associated with the first RS resource set. For example, the resource mapping configuration for an RS resource associated with the second RS resource set may be sparser (e.g., more spacing between time and/or frequency resources) than an RS associated with the first RS resource set. In examples, one or more RS resources associated with the first and/or second RS resource set may be configured with a plurality of transmission periodicities. In examples, the WTRU may receive a configuration and/or indication of the active and/or default periodicity (e.g., out of configured periodicities) associated with an RS resource and/or an RS resource set.

In examples, the WTRU may receive a configuration message (e.g., via RRC, MAC-CE, and/or DCI) associated with one or more thresholds. For example, the configuration message may include an indication of: one or more thresholds for beam quality, one or more thresholds for prediction quality, one or more time-thresholds, one or more periodicity and/or period thresholds, and/or one or more count thresholds.

In examples, the WTRU may receive a configuration message (e.g., via RRC, MAC-CE, and/or DCI) associated with a WTRU SR and/or UL-WUS. In examples, the WTRU may be configured with one or more SR and/or UL-WUS configurations. In examples, one or more SR and/or UL-WUS configurations may be associated with different physical resources. In examples, one or more SR and/or UL-WUS resource may be QCL-related with different RSs (e.g., different RSs may be associated with different beams). In examples, an SR and/or UL-WUS resource may be QCL-related with an RS resource associated with the second resource set. In examples, an SR and/or UL-WUS may be associated with an RS resource (e.g., activated and/or transmitted RS resource) associated with the first RS resource set. In examples, an SR and/or UL-WUS resource may be associated with beam failure detection configuration information. In examples, an SR and/or UL-WUS resource may be associated with beam failure recovery configuration information. In examples, an SR and/or UL-WUS resource may be associated with link recovery configuration information. In examples, an SR and/or UL-WUS resource may be associated with LTM candidate configuration information. In examples, an SR and/or UL-WUS resource may be associated with an RS resource set associated with beam management procedure(s). In examples, an SR and/or UL-WUS resource may be associated with AIML measurement and/or prediction set(s). In examples, the WTRU may be configured with one or more of the following resources associated with transmission of a WTRU request: PRACH, PUCCH, two-step RACH, contention-based resources, and/or the like.

In examples, the WTRU may receive a configuration message (e.g., via RRC, MAC-CE, and/or DCI) associated with a WTRU report. In examples, the WTRU may be configured with one or more WTRU report configurations. In examples, the WTRU may be configured with one or more resources for a beam failure recover request. For example, the WTRU may be configured with one or more RACH and/or PUCCH and/or PUSCH resources associated with a beam failure recovery configuration. In examples, the WTRU may be configured with one or more resources for one or more CSI reports (e.g., CSI report for CSI/beam quality reporting and/or CSI report associated with one or more LTM candidate configurations) associated with the first and/or the second RS resource set. In examples, the WTRU may be configured with one or more resources associated with an AIML inference report.

Embodiments described herein may include one or more methods to trigger and/or request transmission and/or activation for on demand signal(s).

In examples, the WTRU may (e.g., implicitly) assist the network to determine the activation state and/or transmission periodicity of RSs, for example, as a function of a channel measurement. A WTRU may be configured with a CSI reporting configuration, which may include an associated reporting content and/or quantity to monitor and/or measure the channel quality (e.g., RSRP). The WTRU may be configured with a RS resource set associated with the CSI report, which the WTRU may use to determine the channel measurement(s) and/or channel quality used for calculating the reporting content and/or quantities to include in the CSI report. The WTRU may send the CSI report to a network node (e.g., base station). Based on receiving the CSI report, for example, the network may determine the activation state and/or transmission periodicity of RS(s) from the first RS set as a function of the reporting content and/or quantity from the CSI report. To have an (e.g., a common) understanding between WTRU and the network of the activation state and/or transmission periodicity of RS(s) from the first RS set, for example, the WTRU may be configured with activation state threshold(s), which may be linked to the reporting content and/or quantity of the CSI report in one or more of the following ways.

For example, the WTRU may be configured with a CSI report for beam management, where the WTRU may monitor one or more CSI-RSs and/or one or more SSBs. The WTRU may receive the CSI-RS(s) and/or SSB(s) and/or may measure the RSRP per RS. The WTRU may be configured with a threshold (e.g., RSRP value). The WTRU may determine that one or more RSs from the first resource set are activated and/or transmitted with a short/small period, for example, if the RSRP is above a configured threshold. The WTRU may determine that one or more RSs from the first resource set are activated and/or transmitted with a short/small period based on (e.g., after) the WTRU sends the CSI report. A time delay may be configured such that the WTRU may determine that the RSs from the first RS set are activated and/or transmitted with sort period based on a period of time equal to the time delay after the slot where the CSI is report, for example. Additionally or alternatively, one or more thresholds may e configured for one or more other reporting content and/or quantities (e.g., CQI, number of TRPs, rank, number of antenna ports, time/frequency/phase offset, etc.). For example, if the reported CQI and/or rank is above the CQI and/or rank threshold, the WTRU may determine that the RSs from the first set are activated and/or transmitted with shorter period. For example, in multi-TRP CSI reporting, the WTRU may determine the number of TRPs included in the CSI report (e.g., Type II coherent joint transmission (CJT) CSI). If the WTRU indicates a number of TRP in the report that is greater than a TRP threshold, for example, the WTRU may determine that the RSs from the first RS set are activated and/or transmitted with shorter period. Additionally or alternatively, RS(s) from the first RS set may be associated with different TRPs. The WTRU may include the index of TRPs in addition to the number of TRPs in the CSI report. The indices of the RS(s) from the first RS set that are activated may be a function of the TRP indices that are reported. For example, the WTRU may monitor RS(s) from TRP 1-2-3-4 to determine the CSI reporting quantity. The WTRU may report CSI (e.g., for TRP 1 and/or 2). The network may determine to switch the activation state of the TRPs that are not reported (e.g. TRP 3 and/or 4) to off. Based on the reporting of the CSI, for example, the WTRU may determine that RSs from the first set are activated (e.g., only) for the TRPs that are associated with the TRP index(ices) included in the CSI report.

For example, in multi-CSI reporting, the WTRU may be configured to report the inter-TRP time/frequency/phase offset to support multi-TRP deployment(s) with non-ideal backhaul/synchronization. The WTRU may be configured with time/frequency/phase threshold(s). The WTRU may report a time/frequency/phase offset that is above the time/frequency/phase threshold(s). The WTRU may determine that RS(s) from the first RS set are activated (e.g., only) for the TRPs that are below the threshold, for example, based on reporting a time/frequency/phase offset that is above the time/frequency/phase threshold(s).

For example, in network energy saving CSI report(s), the WTRU may be configured with one or more (e.g., multiple) sub configurations. Each sub configuration may be associated with a subset of the antenna ports from the CSI-RS(s) associated with the CSI report. The WTRU may be configured with a threshold number corresponding to a number of antenna ports. The WTRU may report the one or more sub configurations. The WTRU may determine that one or more RSs from the first RS set are activated, for example, if the number of antennas in the report configuration is above a threshold. If different RSs are associated with different subset(s) of antenna ports (e.g., different panels), for example, the WTRU may determine that the subset of RSs from the first RS set corresponding to the reported antenna ports and/or panels are activated.

In examples, the WTRU may be configured with a prediction threshold (e.g., confidence level) to determine a predicted channel measurement and/or quality over a period of time (e.g., RSRP of a beam over the next T seconds after sending the CSI report). The WTRU may determine that the RS(s) from the first RS set are activated and/or transmitted with a short period during the period of T seconds after the slot including the CSI report, for example, if the predicted channel measurement and/or quality is above a threshold.

In examples, the WTRU may determine the activation state of RS(s) and/or transmission periodicity from the first RS set as a function of the aperiodic trigger state of the triggered CSI report index. The aperiodic trigger state may indicate the index(ices) of the RS(s) from the first RS set that are activated; the WTRU may determine the contents of the CSI (e.g., aperiodic-CSI (AP-CSI) as a function of measurement(s) made on activated RS indices.

A WTRU may be configured (e.g., by RRC) and/or indicated (e.g., by MAC CE) with at least one set of detection resources for the purpose of link recovery (e.g., beam failure detection and/or recovery). Each set of detection resources may be associated with a specific bandwidth part, serving cell, and/or QCL-related RS. For each set of detection resources, for example, the WTRU may be configured (e.g., by RRC) and/or indicated (e.g., by MAC CE) with at least one associated set of recovery resources.

For a set of recovery resources, the WTRU may determine whether triggering of RS request is applicable based on one or more of the following. For a set of recovery resources, the WTRU may determine whether triggering of RS request is applicable based on (e.g., explicit) configuration and/or indication for the set of recovery resources. For a set of recovery resources, the WTRU may determine whether triggering of RS request is applicable based on the type of RS configured for the set of recovery resources (e.g., whether the RS corresponds to an SSB, a certain type of SSB, a CSI-RS, and/or a certain type of CSI-RS). For a set of recovery resources, the WTRU may determine whether triggering of RS request is applicable based on whether the RS is identified as (e.g., always) on RS and/or on demand RS.

A set of recovery resources may be associated with a minimum quality threshold (e.g., RSRP threshold configured and/or indicated for this set.

A WTRU may trigger a RS request for a set of recovery resources, for example, if one or more of the following conditions are satisfied. The WTRU may trigger a RS request for a set of recovery resources if beam failure recovery is triggered for an associated set of detection resources (e.g., beam failure indication counter exceeds a threshold). A WTRU may trigger a RS request for a set of recovery resources if the set of recovery resources is not active, and/or the indicated periodicity is larger than a threshold configured for this set of recovery resources.

The WTRU may be configured with a first and/or a second set of recovery resources associated with a given set of detection resources; triggering of RS may not be applicable to the second set (e.g., always on) and/or triggering of RS may be applicable to the first set (e.g., on-demand RS). If beam failure recovery is triggered for the set of detection resources, for example, the WTRU may (e.g., immediately) initiate measurement of second set of recovery resources. The WTRU may (e.g., also) trigger RS request for the first set, for example, if the at least one condition (e.g., as described herein) is satisfied. The WTRU may trigger a RS request for the first set, for example, based on a determination that a period (e.g., period of time) has elapsed since triggering of beam failure recover and/or under one or more condition(s) that the WTRU has not measured a resource from the second set above the minimum quality threshold associated with the second set. The period may be (pre)defined, configured (e.g., by RRC) and/or signaled (e.g., by MAC CE) for the first set and/or for the second set. The WTRU may (e.g., subsequently) report a RS and/or perform transmission (e.g., PRACH) based on a RS satisfying the quality condition(s) from the second and/or first set of recovery resources. The report may include an indication of whether the RS is from the first and/or second set. Additionally or alternatively, the WTRU may report up to N RSs from each set that satisfy the quality condition(s).

In examples, the WTRU may transmit a RS request (RSR) (e.g., for RSs associated with the first set) based on one or more of the following: beam failure detection; lower layer triggered mobility (LTM) (e.g., L1/L2 triggered mobility); a beam management adjustment procedure; one or more AIML parameters; and/or downlink synchronization.

The WTRU may transmit a RS request (RSR) (e.g., for RSs associated with the first set) based on beam failure detection. In examples, the WTRU may transmit an RSR based on the WTRU detection of a beam failure. For example, the WTRU may transmit beam failure recovery (BFR) (e.g., a BFR message) when WTRU's beam failure instance (BFI) count is greater than a BFI count threshold and/or when the WTRU may trigger beam failure recovery. In examples, the WTRU may transmit an RSR based on the condition(s) that candidate RSs and/or RS resource set(s) associated with a failed (e.g., for which beam failure may be detected) BFD RS resource and/or RS resource set(s) may be deactivated, and/or have partial configuration. In examples, the WTRU may transmit an RSR based on the condition that RS(s) and/or RS resource set(s) associated with a failed BFD RS resource and/or RS resource set may have a transmission period longer (or shorter) than a period threshold.

The WTRU may transmit a RS request (RSR) (e.g., for RSs associated with the first set) based on lower layer triggered mobility (e.g., L1/L2 triggered mobility). In examples, the WTRU may transmit RSR based on the condition that beam quality of a RS is greater than a quality threshold. For example, the WTRU may transmit based on the condition that beam quality of RS signal associated with a second RS resource set associated with LTM candidate set is greater than a threshold. In examples, the WTRU may transmit RSR based on the condition that the beam quality of an RS associated with LTM candidate set is greater than a threshold and/or periodicity of the associated RS may be longer than a periodicity threshold.

The WTRU may transmit a RS request (RSR) (e.g., for RSs associated with the first set) based on a beam management adjustment procedure. In examples, the WTRU may transmit an RSR based on the condition that the beam quality of an RS (e.g., RS QCL related with a DL signal and/or channel (e.g., PDCCH/PDSCH)) is less than a quality threshold. In examples, the WTRU may be configure with a default periodicity of P2/P3 RS resource set. The WTRU may transmit an RSR (e.g., to request an increase in transmission periodicity of one or more RS resources associated with the P2/P3 RS resource set) based on, for example, the condition that the beam quality of an RS resource (e.g., RS QCL related with a DL signal/channel (e.g., PDCCH/PDSCH)) is less than a quality threshold.

The WTRU may transmit a RS request (RSR) (e.g., for RSs associated with the first set) based on one or more AIML parameters. In examples, the WTRU may transmit an RSR based on the condition that the prediction quality associated with an AIML is less than a threshold and/or the transmission periodicity associated with the AIML measurement set and/or prediction set may be longer than a periodicity threshold.

The WTRU may transmit a RS request (RSR) (e.g., for RSs associated with the first set) based on downlink synchronization. In examples, the WTRU may transmit an RSR based on the condition that the WTRU may not have and/or lose synchronization with the network/gNB. For example, the WTRU may be configured with a plurality of RSRs. Each RSR may be associated with a bandwidth and/or a carrier/cell. The WTRU may transmit RSR associated with a bandwidth part (BWP) and/or carrier for which the WTRU may be out of sync with the network.

Embodiments described herein may include one or more methods to transmit a WTRU request for activation of on-demand signal(s). A WTRU may transmit a request, for example, to a node-B. In examples, the WTRU may transmit the request for activation and/or increase in periodicity of on-demand signal(s). In examples, the WTRU may transmit the request for activation and/or increase in periodicity of transmission of one or more resources from a first RS resource set.

In examples, a WTRU may select and/or use one or more resources for one or more request transmissions based on one or more conditions, indications, and/or configurations. In examples, the WTRU may receive, be configured, and/or indicated with one or more configuration information and/or indications for determining and/or selecting the resource(s) for the request transmission(s). For example, the configuration(s) may include one or more threshold values, one or more request transmission occasions, one or more request transmission occasion types, and/or the like. In examples, the WTRU may receive the configuration information and/or indication, for example, from a Node-B via one or more of: system information block (SIB), radio resource control (RRC), downlink control information (DCI), medium access control control element (MAC-CE), and/or the like.

In examples, the WTRU may determine, be configured with, and/or indicated to select and/or use one or more request transmission occasions associated with one or more request transmission occasion types. In examples, the WTRU may be configured with a first set of configurations corresponding to one or more first request transmission occasions associated with a first request transmission occasion type; the WTRU may be configured with a second set of configurations corresponding to one or more second request transmission occasions associated with a second request transmission occasion type; and/or the like. The WTRU may select and/or use a request transmission occasion type(s) based on, for example, one or more conditions.

In examples, the different request transmission occasion types may be associated with the type of request signaling. For example, the first request transmission occasion type may be based on SR transmission; the second request transmission occasion type may be based on uplink (UL) wake up signal (WUS) transmission; and/or the like.

In examples, the different request transmission occasion types may be associated with different request types and/or request purposes. For example, the first request transmission occasion type may be based on one or more scenarios where the request is transmitted as part of a BFR procedure; the second request occasion type may be based on one or more scenarios where the request is transmitted as part of LTM procedure, and/or the like.

In examples, the configuration information (e.g., first configuration information, second configuration information, etc.) on the request transmission occasions corresponding to each respective request transmission occasion (e.g., first request transmission occasion, second transmission occasion) may be different and/or the same. In examples, the WTRU may receive the configuration(s) information (e.g., first configuration information, second configuration information, etc.) separately and/or jointly. For example, if the WTRU receives the configuration information(s) separately, the WTRU may receive one or more separate indications on configuration(s) (e.g., the first configuration information, the second configuration information, etc.). For example, if the WTRU receives the configuration information(s) jointly, the WTRU may receive one or more configuration information(s) regarding the first set of configurations, and/or one or more additional information (e.g., including one or more offset values, scaling values, indications, and/or the like. The WTRU may determine the second set of configurations based on, for example, the received first set of configurations and/or the additional information (e.g., as described herein).

In examples, the WTRU may be configured with separate and/or different configurations for different request transmission occasions. In examples, the WTRU may be configured to jointly use one or more same configuration information(s) and/or indications configured for a request transmission occasion type for the request transmission occasions that may be associated with that request transmission occasion type. For example, the WTRU may be configured with a first configuration(s) for a first request transmission occasion type, a second configuration(s) for a second request transmission occasion, and/or the like. The WTRU may consider the configured first configuration(s) for one or more (e.g., all of) the first request transmission occasions corresponding to the first request transmission occasion type; the WTRU may consider the configured second configuration(s) for one or more (e.g., all of) the second request transmission occasions corresponding to the second request transmission occasion type; and/or the like.

In examples, the WTRU may receive one or more first configurations per request transmission occasion. In examples, the WTRU may receive one or more first configurations for each request transmission occasion type. In examples, the request transmission occasion(s) associated with a request transmission occasion type may use the same and/or common first configuration(s). In examples, in the absence of first configuration(s) for a request transmission occasion type, the WTRU may use the first configuration(s) indicated for each request transmission occasion. In examples, in the absent of first configuration(s) for each request transmission occasion, the WTRU may use the first configuration(s) indicated for the associated request transmission occasion type.

In examples, the configuration information on the request transmission occasions may include one or more of the following parameters and/or configurations. One or more of the parameters may (e.g., also) be configured for the request transmission occasion types: a request transmission occasion type; a request transmission occasion index and/or ID; one or more time and/or frequency resources; a TCI-state/beam direction/reference beam/RS; a resource type and/or a periodicity; a carrier; one or more power settings; a total number of request transmission occasions; and/or the like.

The configuration information on the request transmission occasions may include a request transmission occasion type. For example, the WTRU may receive one or more indications on the request transmission occasion type for the request transmission occasion.

The configuration information on the request transmission occasions may include a request transmission occasion index and/or ID. For example, the WTRU may receive an index, ID, identification, and/or the like with regards to the request transmission occasion. In examples, the request transmission occasion ID may be configured with regards to the indicated request transmission occasion type. In examples, the request transmission occasion ID may be associated with a reference signal. For example, one or more consecutive request transmission occasions (e.g., in a cycle) may be associated with one or more reference signals; the request transmission occasion ID may be determined based on the ID of the associated reference signal (e.g., SSB index, CRI, etc.).

The configuration information on the request transmission occasions may include one or more time and/or frequency resources. For example, the WTRU may be configured with the time and/or frequency resource(s) for the request transmission occasion. In examples, the time and/or frequency mapping(s) may be indicated (e.g., explicitly) to the WTRU. In examples, the time and/or frequency resource(s) may be configured with respect to one or more time and/or frequency references and/or one or more configured delta and/or offset time and/or frequency values, respectively. In examples, the starting time of the request transmission occasion(s) may be with regard to Frame 0, an associated SSB, reference signal, associated discontinuous reception (DRX) active and/or inactive time, etc. In examples, the frequency reference point may be with regards to lowest PRB and/or center PRB within the configured component carrier (CC), BWP, etc.

In examples, the one or more request occasions may be configured in a successive pattern. In examples, the placement in time and/or frequency of the request transmission occasions may be determined by a (pre)configured pattern and/or scheme. The WTRU may determine the pattern based on one or configured parameters (e.g., request transmission occasion type, frequency range, subcarrier spacing (SCS), etc.).

The configuration information on the request transmission occasions may include a transmission configuration indicator (TCI)-state and/or beam direction and/or reference beam and/or reference signal. For example, the WTRU may be configured with a TCI-state, QCL-relation, beam direction, and/or reference signal for the request transmission occasion. The WTRU may determine and/or use the uplink spatial filter associated with the indicated TCI-state, beam direction, and/or reference signal for the request transmission in the corresponding request transmission occasion(s). In examples, the WTRU may be configured with (e.g., explicit) indication of the TCI-state. In examples, if the WTRU is configured with association between one or more RSs (e.g., RS indexes) and one or more request transmission occasions, for example, the WTRU may determine and/or use the uplink spatial filter for each request transmission occasion based on its associated reference signal.

The configuration information on the request transmission occasions may include a resource type and/or a periodicity. For example, the WTRU may be configured with the resource type for the request transmission occasion. In examples, the request transmission occasion(s) may be periodic, semi-persistent, and/or aperiodic. The WTRU may receive the configuration information, for example, based on the configured resource type. For example, the WTRU may receive one or more configurations including one or more of periodicity, offset values, etc. In examples, the WTRU may receive the one or more configurations on the resource types and/or periodicity per request transmission occasion. In examples, the WTRU may receive one or more configurations on the resource type and/or periodicity for each request transmission occasion type.

The configuration information on the request transmission occasions may include a carrier. For example, the WTRU may receive one or more indications on the carrier of the request transmission occasion. In examples, the WTRU may receive the configuration(s) on the carrier per request transmission occasion. In examples, the WTRU may receive configuration(s) on the carrier for each request transmission occasion type.

The configuration information on the request transmission occasions may include one or more power settings. For example, the WTRU may receive one or more indications on the uplink power setting(s) and/or uplink target power for the request transmission occasion. In examples, the WTRU may receive the configuration(s) on the power setting(s) per request transmission occastion. In examples, the WTRU may receive configuration(s) on the power setting(s) for each request transmission occasion type. The configuration(s) on the power setting(s) may include one or more power offset values. The WTRU may use the configured power offset value(s) with respect to the measured power of a (pre)configured and/or indicated reference signal (e.g., primary synchronization signal (PSS), secondary synchronization signal (SSS), channel state information (CSI)-RS, etc.).

The configuration information on the request transmission occasions may include a total number of request transmission occasions. For example, the WTRU may be configured with the total number of request transmission occasions within a cycle. A request transmission occasions cycle may be and/or include a time window during which total number of request transmission occasions are configured. In examples, the WTRU may receive the configuration(s) on the total number per request transmission occasion cycle. In examples, the WTRU may receive configuration(s) on the total number for each request transmission occasion type.

A WTRU may determine, be triggered, activated, configured, and/or indicated to send one or more requests, for example, in one or more configured request transmission occasions. The WTRU may receive one or more configuration information(s) on transmission of a request. For example, the WTRU may receive the configuration information(s) (e.g., from a node-B, via SIB, RRC, MAC-CE, DCI, etc.).

A request transmission occasion may be and/or include one or more of the following. A request transmission may be and/or include an activation and/or increase (e.g., an indication that indicates to activate and/or increase) in periodicity. A request transmission may be and/or include a deactivation and/or decrease (e.g., an indication that indicates to deactivate and/or decrease) in periodicity. For example, the WTRU may receive one or more indications on the request transmission occasion(s) and/or request transmission occasion types to be used for the request transmission. In examples, the WTRU may receive one or more indications on one or more activated and/or deactivated request transmission occasions and/or request transmission occasion types. In examples, the WTRU may receive the request transmission occasion(s) ID(s) that may be activated to be used. In examples, the WTRU may determine the request transmission occasion(s) to be used based on the mode of operation, indicated request transmission occasion type, etc. In examples, the WTRU may receive one or more (e.g., additional) configuration information(s) to be used to request transmission in one or more request transmission occasions. For example, the WTRU may receive the UL TCI-state, carrier, power settings, etc. In examples, if the WTRU receives one or more additional configuration(s), the additional configuration(s) may (e.g., partially and/or fully) override one or more of the (pre)configured settings received in the request transmission occasions.

A WTRU may receive one or more indications on the number of repetitions of the request(s) to be transmitted in one or more request transmission occasions. In examples, the WTRU may receive the configuration(s) on the number of repetitions per request transmission occasion. In examples, the WTRU may receive configuration(s) on the number of repetitions for each request transmission occasion type. In examples, the WTRU may be (e.g., explicitly) configured with the number of repetitions to be used. In examples, the WTRU may determine the number of repetitions based on one or more threshold values and/or one or more measured quality parameters. For example, if the measured RSRP (e.g., measured based on one or more mode reference signals (e.g., SSB, CSI-RS, etc.) is lower than a first threshold, the WTRU may determine to repeat the request transmission for a first number of times; if the measured RSRP is lower than a second threshold, the WTRU may determine to repeat the request transmission for a second number of times; and/or the like.

The WTRU may receive one or more configuration information(s) on one or more methods for the transmission of a request. In examples, the WTRU may send the request via uplink control information (UCI), MAC-CE, RRC, and/or the like. For example, one or more of the following may apply: an (e.g., uplink) control channel (e.g., PUCCH), a SR resource, and/or a RACH resource.

For example, a WTRU may determine, be configured, and/or indicated to transmit the request based on one or more (e.g., PUCCH) resources. For example, the WTRU may use one or more (pre)configured (e.g., UCI) resources for transmitting the request. In examples, the WTRU may receive one or more configuration information(s) to be used (e.g., PUCCH resources, frequency hopping, type of PUCCH (e.g., short PUCCH, long PUCCH, etc.) cyclic shift, power setting(s), and/or the like).

For example, the WTRU may determine, be configured, and/or indicated to transmit the request based on one or more (pre)configured SR resources. In examples, the WTRU may receive one or more configuration information(s) to be used (e.g., SR ID, SR periodicity, and/or the like).

For example, a WTRU may determine, be configured, and/or indicated to transmit the request based on one or more RACH occasions (ROs). In examples, the WTRU may receive one or more configuration information(s) to be used. For example, the WTRU may be (pre)configured with the PRACH preamble to be transmitted. In examples, the WTRU may (e.g., randomly) select a PRACH preamble to be transmitted. In examples, the WTRU may receive the (e.g., explicit) indication on the RO(s) to be used. In examples, the WTRU may be configured with at least a RS (e.g., SSB index, CSI, etc.); the WTRU may select one or more associated ROs to send the PRACH preamble based on, for example, the configuration of at least one RS. In examples, the WTRU may determine the ROs based on a selected and/or determined RS (e.g., SSB, CSI-RS, etc.) and/or the corresponding RS-to-RO mapping.

The WTRU may be configured with one or more requests. The WTRU may use one or more methods to indicate the request, for example, based on one or more of the following: preamble partitioning, RO, PUSCH Occasion (PO), Msg 3, and/or the like. The WTRU may use the same purpose to send one or more (e.g., two) requests (e.g., for reliability and/or enhancing coverage). For example, the WTRU may use a method to send a request per one purpose of the request.

The WTRU may use one or more methods to indicate the request, for example, based on a preamble partitioning. For example, the WTRU may determine, be configured, and/or indicated to use preamble partitioning for indicating one or more requests. In examples, the WTRU may be configured to use a PRACH preamble from a first subset of preambles, if the WTRU determines to send a first request based on a (e.g., first) purpose (e.g., BFR RS request); the WTRU may be configured to use a PRACH preamble from a second subset of preambles, for example, if the WTRU determines to send a second request based on a (e.g., second) purpose) (e.g., LTM RS request); and/or the like.

The WTRU may use one or more methods to indicate the request, for example, based on RO. For example, the WTRU may be configured with one or more ROs, associated with one or more different requests, where the WTRU may use a (e.g., first) RO, if the WTRU determines to send a (e.g., first) request based on a (e.g., first) purpose; the WTRU may use a (e.g., second) RO, if the WTRU determines to send a (e.g., second) request based on a (e.g., second) purpose; and/or the like.

The WTRU may use one or more methods to indicate the request, for example, based on one or more PUSCH Occasions (POs). For example, the WTRU may be configured with one or more POs, in 2-step RACH for MsgA PUSCH transmission. The different POs may be associated with one or more different requests. The WTRU may use a (e.g., first) PO, for example, if the WTRU determines to send a (e.g., first) request based on a (e.g., first) purpose; the WTRU may use a (e.g., second) PO, for example, if the WTRU determines to send a (e.g., second) request based on a (e.g., second) purpose; and/or the like.

The WTRU may use one or more methods to indicate the request, for example, based on Msg 3. For example, the WTRU may be configured to indicate the request as a part of Msg 3 and/or Msg A transmission.

Based on and/or after PRACH preamble (e.g., Msg1) and/or Msg A transmission, for examples, a WTRU may be configured to monitor to receive a response message (e.g., random access response (RAR) message). The WTRU may receive the response message (e.g., RAR), for example, within a configured time window. In examples, the WTRU may not monitor to receive RAR and/or the WTRU may monitor to receive the (e.g., requested) RS(s).

A WTRU may, for example, determine, be configured, and/or indicated to transmit the request(s) based on one or more UL WUS(s). In examples, the WTRU may receive one or more configuration information(s) to be used. For example, the WTRU may be (pre)configured with one or more codepoints, sequences, and/or the like to be transmitted.

The WTRU may be configured with (e.g., overlaid OFDM) sequence(s) to be transmitted in one or more symbols, on one or more request transmission occasions. For example, the UL WUS sequence(s) may be based on Zadoff-Chu sequence(s), M-sequence(s), gold sequence(s), computer generated sequence(s), and/or the like. The WTRU may be configured with binary sequences to be transmitted in one or more (e.g., OFDM) symbols on one or more request transmission occasions. In examples, the sequence(s) may extend on more than one request transmission occasion(s).

The WTRU may be configured with the sequence's length. In examples, the WTRU may be configured with the number of UL-WUS repetitions in one or more request transmission occasions. In examples, the WTRU may be configured with WTRU-specific sequence(s); the WTRU may be configured with group-specific sequence(s); the WTRU may be configured cell-common sequences(s); and/or the like. Based on and/or after UL-WUS transmission, for example, the WTRU may be configured to monitor to receive a response (e.g., response message, similar to RAR, within a configured time window, etc.). In examples, the WTRU may not (e.g., expect to) receive a response (e.g., response message) and/or the WTRU may monitor to receive the (e.g., requested) RS(s).

A WTRU may determine, be configured, and/or indicated to transmit the request on one or more common, shared, and/or contention-based resources, for example. The WTRU may be configured to use a WTRU-specific, group-specific, and/or cell-common indication(s) in one or more shared resources. The indication may be based on one or more sequences. The WTRU may determine, be configured, and/or indicated with one or more shared resources. The indication may be based on one or more sequences. The WTRU may determine, be configured, and/or indicated with one or more shared resources. The different shared resources may be associated with one or more different requests. The WTRU may use a (e.g., first) set of shared resources for transmission, for example, if the WTRU determines to send a (e.g., first) request based on a (e.g., first) purpose; the WTRU may use a (e.g., second) set of shared resources for transmission, for example, if the WTRU determines to send a (e.g., second) request based on, for example, a (e.g., second) purpose; and/or the like.

A WTRU may determine, be configured, and/or indicated to use one or more MAC-CE resources for request transmission, for example. The WTRU may be configured with one or more codepoints, indexes, and/or the like to be transmitted in MAC-CE resource(s). The WTRU may use the MAC-CE indication for indicating one or more request purposes.

In examples, a WTRU may determine, be configured, and/or indicated to use one or more hybrid methods for the transmission of one or more requests. For example, the WTRU may transmit one or more UCI based on, after, and/or following the transmission of one or more SRs. In examples, the WTRU may send the UCI if the transmitted SR is mapped and/or associated with one or more (e.g., BFR) CORESETS and/or beam failure detection (BFD)-RS set(s), LTM candidate(s), CSI-report(s) (e.g., CSI-reports for AIML inference), and/or the like. In examples, the UCI may include information about one or more of the following: beam-failure indication(s); LTM indication(s); RS resource indication(s); and/or the like. In examples, the UCI may include information about beam-failure indication(s). For example, the UCI may include one or more indications on one or more CORESETS and/or BFD-RS sets for which a beam failure is detected. In examples, the UCI may include information about LTM indication(s). For example, the UCI may include one or more indications on one or more LTM candidates associated with the SR. In examples, the UCI may include information about RS resource indication(s). For example, the UCI may include one or more indications on one or more RS resources. In examples, the RS resource(s) may be associated with AIML measurement set(s).

In examples, the WTRU may select one or more request transmission occasions for the configured occasion(s) based on one or more conditions, configurations, and/or threshold values. A WTRU may select one or more request transmission occasions based on: a beam-based determination; an activated and/or deactivated based determination; a mode of operation; one or more transmission configurations; a carrier frequency; and/or the like. One or more of the following may apply.

A WTRU may select one or more request transmission occasions based on a beam-based determination. For example, the WTRU may select a request transmission occasion based on one or more beam quality parameters. In examples, the WTRU may select a first request transmission occasion that is associated with a first beam prediction if the WTRU determines and/or is indicated to send the request based on the first beam. The WTRU may select the first beam based on one or more quality parameters (e.g., highest measured RSRP, etc.).

A WTRU may select one or more request transmission occasions based on an activated and/or deactivated based determination. For example, the WTRU may select a request transmission occasion based on the set of activated and/or deactivated request transmission occasion(s) and/or request transmission occasion type(s). The WTRU may select a request transmission occasion from the set of activated request transmission occasion(s) and/or request transmission occasion type(s). In examples, the WTRU may determine, be configured, and/or indicated with the set of activated and/or deactivated request transmission occasion(s) and/or request transmission occasion type(s). For example, the WTRU may receive one or more configuration information(s) on one or more time windows and/or time windows, during which the WTRU may consider one or more request transmission occasions and/or request transmission occasion type(s) activated and/or deactivated. In examples, the WTRU may receive the time-window based on milli-sec, micro-sec, number of symbols, slots, frames, etc.

A WTRU may select one or more request transmission occasions based on a mode of operation. For example, the WTRU may select a request transmission occasion based on the purpose of the request. For example, the WTR Umay select a (e.g., first) request transmission occasion if the WTRU transmits a (e.g., first) request based on a (e.g., first) purpose (e.g., request for BFR candidate RS); the WTRU may select a (e.g., second) request transmission occasion, for example, if the WTRU transmits a (e.g., second) request based on a (e.g., second) purpose (e.g., request for LTM candidate RS); and/or the like.

A WTRU may select one or more request transmission occasions based on one or more transmission configurations. For example, the WTRU may select a request transmission occasion based on one or more transmission conditions. In examples, the WTRU may select the request transmission occasion based on the number of active Tx chains. For example, the WTRU may prioritize request transmission occasion(s) in the (e.g., currently, active) carrier if the number of Tx chains that are ON is lower than a (pre)configured number (e.g., if only 1 Tx chain is ON).

A WTRU may select one or more request transmission occasions based on a carrier frequency. For example, the WTRU may select a request transmission occasion based on the carrier frequency. In examples, the WTRU may determine to use the occasion(s) in low frequency carriers.

A WTRU may receive one or more indications based on and/or after transmission of one or more requests. In examples, the indication(s) may be based on confirmation of activation and/or increase in periodicity of one or more RS resources associated with the (e.g., first) RS resource set. In examples, the WTRU may stop request transmission if the WTRU receives at least a confirmation indication. For example, the received indication may include one or more configurations and/or indications, where one or more of the following may apply: a (e.g., an explicit) indication, a bitmap-based indication; and/or an indication that indicates one or more (e.g., all) RS(s) may be activated; and/or the like.

The WTRU may receive an (e.g., explicit) indication. In examples, the WTRU may receive one or more configuration information(s) on the activated RS resource(s), RS resource set(s), and/or the like. In examples, the WTRU may receive configuration(s) on the resource mapping of the activated RS resources.

The WTRU may receive a bitmap-based indication. In examples, the WTRU may receive one or more bitmap-based indications. Each bit may be associated with an RS resource. In examples, a first value of each bit (e.g., value one) may indicate the activation and/or increase in periodicity of the corresponding RS within the first RS resource set; a second value of each bit (e.g., value zero) may indicated the deactivation and/or decreased and/or unchanged periodicity of the corresponding RS.

The WTRU may receive an indication that indicates one or more (e.g., all) RSs may be activated. In examples, the WTRU may receive a flag indication (e.g., 1-bit indication) indicating that one or more (e.g., all) RS resources associated with the first RS resource set may be activated and/or transmitted with shorter period.

In examples, the WTRU may retransmit one or more requests in one or more request transmission occasions if the indication confirming the activation of RSs is not received within a (pre)configured time window.

Embodiments described herein may include one or more methods for WTRU feedback/report/response based on and/or after reception of on demand signals.

In examples, the WTRU may measure RS(s) associated with the first RS resource set (e.g., RS resources which may be activated and/or for which transmission parameter(s) may be configured and/or indicated to the WTRU) and/or second RS resource set. Based on the measurements, for example, the WTRU may determine one or more beam qualities (e.g., RSRP, SINR, CQI, PMI, RI, SNR, etc.) associated with the measured RSs. The WTRU may determine one or more of the following based on the beam quality(ies).

The WTRU may determine a candidate RS for beam failure recovery based on the measured beam quality(ies). For example, the WTRU may determine one or more candidate RSs associated with the highest quality beam(s) to report in a BFR request. For example, the WTRU may select a first candidate RS with beam quality greater than a beam quality threshold to report in a BFR request. For example, the WTRU may determine a plurality of candidate RSs based on the condition that a beam failure may be detected by the WTRU on plurality of BFD RS resource sets.

The WTRU may determine content of a CSI-report and/or CSI-report for LTM based on the measured beam quality(ies). For example, the WTRU may report CRI and/or associated beam quality(ies) of one or more (e.g., Top M where M may be configured in CSI-report configuration and/or indicated via MAC-CE and/or DCI) RSs associated with the first and/or second RS resource set(s) in a CSI-report. In examples, the WTRU may report one or more beam quality(ies) of one or more RSs associated with one or more LTM candidate sets. For example, the WTRU may report CRI and/or beam quality of the RS with the highest beam quality associated with one or more (e.g., all of them) candidate LTM configuration(s).

The WTRU may determine content of AIML inference report based on the measured beam quality(ies). For example, the WTRU may predict the highest quality beam(s) from a prediction set (e.g., first and/or second RS resource set) and/or predicted beam quality(ies). The WTRU may report CRI/beam IDs Top-K (e.g., where K may be configured in CSI-report configuration and/or indicated via MAC-CE and/or DCI) beams and/or Top-K predicted beam qualities in the inference report.

The WTRU may transmit a beam failure recovery request indicating one or more candidate RS resources in one or more of the following ways.

The WTRU may transmit one or more BFT requests using MAC-CE associated with an UL resource. The WTRU may indicate one or more (e.g., a plurality of) candidate RSs (e.g., when a beam failure may be detected on the plurality of BFD RS resource sets). In examples, the WTRU may select an UL resource for the transmission of a BFR request based on a received indication and/or configuration (e.g., via MAC-CE, DCI, and/or RRC) indicating an UL resource for BFR request transmission(s). In examples, the WTRU may receive an indication indicating activation and/or deactivation for one or more UL resources for transmission of BFR-request. In examples, the activation and/or deactivation condition(s) may be valid and/or applicable for a period of time (e.g., X msec, slots, frames, etc.; X may be indicated and/or configured to the WTRU). The WTRU may transmit a BFR request in an activated UL resource. In examples, the WTRU may select a UL resource to transmit a BFR request based on one or more of the following: a number of candidate RSs to be reported in BFR request; a beam quality of an RS QCL-related with a UL resource; based on the associated BFD resource set; based on the carrier frequency; and/or based on the Tx chain of the WTRU.

The WTRU may select a UL resource to transmit a BFR request based on the number of candidate RSs to be reported in BFR request. For example, the WTRU may select a UL resource based on the number of BFD resource sets for which a beam failure may be detected (e.g., based on the number of cells and/or carriers for which a beam failure may be detected). In examples, the WTRU may select a UL resource based on the number of BFD resource sets in the same BWP for which a beam failure is detected (e.g., based on the number of TRPs for which a beam failure may be detected).

The WTRU may select a UL resource to transmit a BFR request based on a beam quality of an RS QCL-related with a UL resource. For example, the WTRU may select a UL resource which may be QCL-related with an RS with associated beam quality greater than a beam quality threshold. In examples, the WTRU may select a UL resource which may be associated with an RS with the highest associated beam quality.

The WTRU may select a UL resource to transmit a BFR request based on the associated BFD resource set. The WTRU may be configured with different UL resources for BFR recovery for different BFD resource sets (e.g., for different CORESETS). The WTRU may select a UL resource associated with the BFD resource set for which a beam failure may be detected by the WTRU.

The WTRU may select a UL resource to transmit a BFR request based on the carrier frequency. The WTRU may prioritize transmission of BFR reques(s) in a first carrier, for example. For example, the WTRU may select the UL resource of a BFR request in a low frequency carrier (e.g., when beam quality(ies) associated with RSs resource(s) QCL-related with the UL resources are less than a beam quality threshold).

The WTRU may select a UL resource to transmit a BFR request based on Tx chain of WTRU. The WTRU may prioritize transmission of the BFR request(s) in a first Tx RF chain of the WTRU. For example, the WTRU may select a UL resource associated with the (e.g., currently active) carrier (e.g., active RF chain). In examples, the WTRU may transmit BFR request(s) in a different (e.g., than currently active) carrier based on the condition that the beam quality of RS resource QCL-related with the BFR request resource in the (e.g., currently active) carrier is less than a quality threshold.

Based on the condition that there may be no UL resources available for transmission of BFR request, for example, the WTRU may transmit (e.g., based on and/or following the one or more transmission occasion request methods as described herein) a link recovery request, resource request (e.g., SR). Based on the transmission of the WTRU request, for example, the WTRU may receive an indication and/or configuration of one or more UL resources for transmission of BFR request(s).

In examples, the WTRU may transmit one or more BFR requests using RACH mechanism(s) (e.g., using contention free random access). In examples, the WTRU may transmit one or more BFR requests using PRACH based on the condition that a beam failure may be detected on one or more (e.g., all) the configured BFD resource sets. In examples, the WTRU may transmit one or more BFR requests using PRACH based on the condition that a beam failure may be detected on a configured BFD resource set associated with an anchor carrier and/or cell (e.g., Primary Cell (PCell), special cell (SpCell), etc.). In examples, the WTRU may transmit one or more BFR request using PRACH based on the condition that beam-quality(ies) of one (e.g., the one associated with an anchor cell and/or carrier) or more (e.g., all of them) RSs associated with UL resource(s) for BFR request transmission is less than a beam quality threshold.

In examples, the WTRU may select a UL resource for transmission of a CSI-report, LTM CSI-report, and/or AIML inference report based on payload size. For example, the WTRU may select a UL resource based on the number of RSs activated within the first RS resource set and/or the number of RSs measured from the second RS resource set. In examples, the WTRU may select a UL resource based on the number of measured and/or predicted beam quality(ies), CRIs, and/or beam IDs to be reported in the report. In examples, the WTRU may select a UL resource based on one or more of: beam quality of RS QCL-related with UL resource (e.g., the WTRU may select UL-resource associated with highest beam quality), type of report (e.g., whether CSI-report, CSI for LTM and/or AIML inference report), carrier frequency, active carrier/cell and/or received configuration, and/or periodicity of report (e.g., periodic, semi-persistent, and/or aperiodic).

Embodiments described herein may include one or more methods to deactivate transmission of on demand signal(s).

A WTRU may be configured to receive an indication from the network indicating to the WTRU that one or more (e.g., multiple) RS resources from an RS resource set may be deactivated and/or not transmitted and/or transmitted with longer periodicity by the network. Based on and/or after receiving such indication, for example, the WTRU may determine that the indicated RS resource(s) may be disabled RS resource(s) and/or the WTRU may stop monitoring the disabled RS resource(s). The disabled RS resource(s) may be a part of the first RS resource set/on-demand RS set(s) requested by the WTRU. For example, the WTRU may be configured with an on-demand RS resource set, initially not transmitted and/or transmitted with a long periodicity by the network, and/or the WTRU may request the network to transmit and/or increase the periodicity of one or more RS resources from the configured first RS (e.g., on demand RS) resource set. Based on and/or after receiving the requested RS transmission(s), for example, the WTRU may receive an indication from the network indicating that one or more of the requested RS resources may be disabled; the WTRU may stop monitoring the indicated RS resource(s). The WTRU may be configured to receive an indication from the network indicating that one or more (e.g., some) RS resources may be activated while other RS resources may be deactivated (e.g., the network may transmit new RS resources while stop transmitting other RS resources). In examples, the WTRU may be configured to receive a DCI indicating that one or more (e.g., multiple) RS resources from the first RS resource set and/or on-demand RS are deactivated and/or activated (e.g., not transmitted and/or transmitted by the network) and/or transmitted with shorter period. The WTRU may receive a bitfield in a DCI indicating one or more RS resources from the first (e.g., on-demand) RS resource set may be deactivated and/or activated and/or transmitted with a short and/or long period. For example, the value of the bitfield in the DCI may indicate a combination of RS resources from the on-demand RS resource set that are deactivated and/or activated. In examples, the WTRU may be configured to receive a MAC CE within a PDSCH indicating that one or more (e.g., multiple) RS resources from the on-demand RS set/first RS resource set may be deactivated and/or activated. Additionally or alternatively, the WTRU may be configured to receive higher layer configuration(s) (e.g., an RRC (re)configuration) indicating that one or more (e.g., multiple) RS resources from the on-demand RS and/or first RS set(s) may be deactivated and/or activated and/or transmitted with long and/or short period. In examples, the WTRU may receive an indication of periodicity for one or more RS resources and/or RS resource sets.

In examples, the WTRU may be configured to determine whether an RS resource from the on-demand RS resource set and/or first RS resource set may be deactivated and/or may be transmitted with a default (e.g., long) transmission periodicity based on one or more of the following: transmission of BFR request; transmission of CSI-report; time duration after the activation of the RS resource; and/or time duration after transmission of BFR request and/or CSI report associated with the on-demand RS resource set/first RS resource set.

The WTRU may be configured to determine whether an RS resource from the on-demand RS resource set and/or first RS resource set may be deactivated and/or may be transmitted with a default (e.g., long) transmission periodicity based on transmission of BFR request. The WTRU may be configured to deactivate an RS resource from the on-demand RS resource set and/or RS resource set (e.g., the WTRU may stop monitoring the RS resource) based on the condition that the WTRU may transmit to the network a beam failure recovery request. The WTRU may be configured to deactivate and/or stop monitoring the RS resource in the slot(s) based on and/or after the slot when the WTRU transmitted the BFR request. Additionally or alternatively, the WTRU may be configured to deactivate and/or stop monitoring the RS resource before a (pre)configured number of slot(s) prior to the slot when the WTRU transmitted the BFR request(s).

The WTRU may be configured to determine whether an RS resource from the on-demand RS resource set and/or first RS resource set may be deactivated and/or may be transmitted with a default (e.g., long) transmission periodicity based on reception of a BFR request response. The WTRU may be configured to deactivate and/or stop monitoring an RS resource from the on-demand RS resource set and/or first RS resource set when the WTRU receives a BFR request response from the network. For example, the WTRU may transmit the BFR request to the network and/or may receive a RACH response. Based on and/or following the reception of RAR, for example, the WTRU may stop monitoring the RS resource.

The WTRU may be configured to determine whether an RS resource from the on-demand RS resource set and/or first RS resource set may be deactivated and/or may be transmitted with a default (e.g., long) transmission periodicity based on transmission of a CSI report. The WTRU may be configured to deactivate and/or stop monitoring an RS resource from the on-demand RS resource set and/or first RS resource set, for example, when the WTRU transmits a CSI-report to the network for a set and/or subset of CSI-report configuration(s). For example, the WTRU may be configured with an association between RS resource(s) and CSI report configuration ID(s). When the WTRU transmits a CSI report that has a CSI report configuration ID associated with the RS resource, for example, the WTRU may stop monitoring and/or may deactivate the RS resource(s).

The WTRU may be configured to determine whether an RS resource from the on-demand RS resource set and/or first RS resource set may be deactivated and/or may be transmitted with a default (e.g., long) transmission periodicity based on a time duration based on and/or after the activation of the RS resource(s). For example, the WTRU may be configured to start a timer based on and/or after the activation of an RS resource(s) from the on-demand RS resource set and/or the first RS resource set. Upon expiry of the timer, for example, the WTRU may deactivate and/or may stop monitoring one or more RS resources.

The WTRU may be configured to determine whether an RS resource from the on-demand RS resource set and/or first RS resource set may be deactivated and/or may be transmitted with a default (e.g., long) transmission periodicity based on a time duration based on and/or after transmission of BFR request and/or CSI report associated with the on-demand RS resource set and/or first RS resource set. For example, the WTRU may be configured to start a timer based on and/or after transmitting a BFR request and/or a CSI report. Upon expiry of the timer, for example, the WTRU may deactivate and/or may stop monitoring one or more RS resources.

Embodiments described herein may include one or more methods for handling of overlapping RSs. The WTRU may receive an indication and/or configuration for the reception of more than one RS and/or RS set according to at least one of the embodiments described herein, for example. For a first RS and/or a second RS, overlap may occur for the time and/or frequency resource(s) occupied by the first RS and/or the second RS. The WTRU may determine a prioritized RS between the first RS and the second RS and/or may perform one or more of the following actions. The WTRU may receive on the prioritized RS according the corresponding function (e.g., beam failure recovery, synchronization, etc.). For example, two sets of RSs may have RSs with overlapping time-frequency resource(s). In examples, a priority may be assigned to overlapping RSs. The WTRU may measure the high priority RS(s). The priority of an RS may be different based on, for example, a WTRU function (e.g., a RS may have high priority when the WTRU is measuring that RS for the purpose of beam failure recover, and/or low priority otherwise). The WTRU may skip reception on a non-prioritized RS on one or more (e.g., any) overlapping resources, and/or on one or more (e.g., any) instance of a set of recurring instances of the non-prioritized RS for which overlap exists for a subset of the resource(s).

The WTRU may determine a prioritized RS using at least one or more of the following. The WTRU may assign a priority level to each RS and/or may determine the prioritized RS as the RS with highest priority level among overlapping RS.

The WTRU may determine a priority level according to one or more of the following. The WTRU may determine a priority level according to a priority level (e.g., explicitly) indicated and/or configured for the RS. For example, the priority level may be indicated in a MAC CE and/or DCI triggering the RS. For example, the priority level may be signaled by RRC. The WTRU may determine a priority level according to whether the RS recurs periodically and/or occurs in one and/or a limited number of instances. For example, an RS that includes a single instance may have a higher priority than an RS that is periodic. The WTRU may determine a priority level according to whether the RS recurs indefinitely (e.g., always on) according to a (pre)determined and/or semi-static configuration(s) and/or may be triggered dynamically (e.g., on-demand). The WTRU may determine a priority level according to the type of RS, such as whether the RS corresponds to a system synchronization block (SSB), a specific type thereof, and/or a CSI-RS. For example, an SSB of a first type may have a higher priority than an SSB of a second type. The WTRU may determine a priority level according to a parameter used to generate at least one portion of the RS, such as a scrambling identity and/or a physical cell identity. The WTRU may determine a priority level according to the configured and/or indicated periodicity of the RS. For example, an RS with a larger periodicity may have higher priority than an RS with a smaller periodicity. The WTRU may determine a priority level according to a priority associated with the procedure for which the RS was triggered. For example, an RS triggered by a beam failure recovery procedure may have a higher priority than an RS triggered by a CSI request. The WTRU may determine a priority level according to a priority level configured for the uplink resource used for the RS request and/or configured for the event triggering the transmission of the RS request. The WTRU may determine a priority level according to whether the RS is a main and/or fallback RS (e.g., as described herein).

For a first RS, for example, the WTRU may receive configuration of a second RS on which the WTRU may receive in case the first RS is deprioritized. The first RS may be referred to as a main RS. The second RS may be referred to as a fallback RS. The configuration of the fallback RS may reuse one or more (e.g., some) parameters of the configuration of the main RS. For example, the time and/or frequency instance(s) of a periodically recurring fallback RS may correspond to the time and/or frequency instance(s) of a periodically recurring main RS, and/or (e.g., plus) a configurable offset. In case main RS is deprioritized for a given instance, for example, the WTRU may receive on corresponding instance(s) of the associated fallback RS.

A WTRU may receive configuration information. The configuration information may include BFR configuration information, a first RS resource set, and/or a second RS resource set. At least one RS resource associated with the first RS resource set may be configured with an activation/deactivation state. BFR configuration information may include information of candidate RS resource set(s) that the WTRU may measure to find a (e.g., new) beam. Additionally or alternatively, BFR configuration may include a configuration of one or more methods to transmit BFR message by the WTRU. The content of BFR message may be and/or include an indication of candidate RS associated with a (e.g., new) beam. The WTRU may receive a (e.g., first) indication that at least one RS resource of the first RS resource set has been activated (e.g., based on the configuration information). The WTRU may send a BFR message to a base station based on the BFR configuration information. The BFR message may include an indication of one or more measurements performed on the activated at least one RS resource. The BFR message may be sent using the second RS resource set. The WTRU may receive a (e.g., second) indication that the at least one RS resource has been deactivated (e.g., based on the condition that an RS resource configured with an activation/deactivation state may be associated with the configuration information).

A WTRU may receive configuration information. The configuration information may include CSI configuration information, a first RS resource set, and/or a second RS resource set. At least one RS resource associated with the first RS resource set may be configured with an activation/deactivation state. The configuration information of CSI report may include one or more resources for CSI-report transmission and/or associated RS resource set(s) on which the WTRU may perform RS measurement(s). The content of CSI report may be and/or include one or more WTRU measurements of RS resource set(s) configured with the CSI report. The WTRU may receive a (e.g., first) indication that at least one RS resource of the first RS resource set has been activated (e.g., based on the configuration information). The WTRU may send a CSI message to a base station based on the BFR configuration information. The CSI message may include an indication of one or more measurements performed on the activated at least one RS resource. The CSI message may be sent using the second RS resource set. The WTRU may receive a (e.g., second) indication that the at least one RS resource has been deactivated (e.g., based on the condition that an RS resource configured with an activation/deactivation state may be associated with the configuration information).

A WTRU may receive configuration information. The configuration information may include BFR configuration information, CSI configuration information, a first RS resource set, and/or a second RS resource set. At least one RS resource associated with the first RS resource set may be configured with an activation/deactivation state. BFR configuration information may include information of candidate RS resource set(s) that the WTRU may measure to find a (e.g., new) beam. Additionally or alternatively, BFR configuration may include a configuration of one or more methods to transmit BFR message by the WTRU. The content of BFR message may be and/or include an indication of candidate RS associated with a (E.g., new) beam. The configuration information of CSI report may include one or more resources for CSI-report transmission and/or associated RS resource set(s) on which the WTRU may perform RS measurement(s). The content of CSI report may be and/or include one or more WTRU measurements of RS resource set(s) configured with the CSI report. BFR candidate RS resource set(s) and/or CSI report RS resource set(s) may be associated with an OD-RS set. A WTRU may receive a configuration of a first RS resource set (e.g., on demand RS set), which may be associated with one or more beam failure recover (BFR) configurations, lower layer triggered mobility (LTM) candidate(s), and/or CSI report(s). The RSs may be activated based on CSI-report(s) and/or transmission of a RS request from a WTRU. The WTRU may measure one or more activated RSs associated with the first (e.g., RS) resource set. The WTRU may transmit a BFR request and/or a CSI-report. The first RS resource set may be associated with one or more of a BFR configuration, a lower layer triggered mobility (LTM) configuration, a channel state information (CSI)-report configuration, and/or one or more artificial intelligence machine learning (AIML) sets. AIML sets may refer to measurement resource set(s) (e.g., input) and/or prediction resource set(s) (e.g., output), which may be applicable to one or more (e.g., any) AIML models.

A WTRU may receive configuration information. The configuration information may include one or more of the following. The configuration information may include a (e.g., first) RS resource set configured with an activation state and/or a plurality of transmission periodicities. The (e.g., first) RS resource set may be associated with BFR configuration(s), LTM configuration(s), CSI-report(s), and/or artificial intelligence machine learning (AIML) set(s). AIML sets may refer to measurement resource set(s) (e.g., input) and/or prediction resource set(s) (e.g., output), which may be applicable to one or more (e.g., any) AIML models. The configuration information may include a (e.g., second) RS resource set. The (e.g., second) RS resource may be associated with one or more transmission resources for one or more WTRU requests. The configuration information may include one or more thresholds (e.g., beam quality threshold(s), time threshold(s), prediction quality threshold(s)). The configuration information may include report and/or request configuration information: RS request (RSR) configuration (e.g., via scheduling request (SR), uplink (UL)—wake up signal (WUS), physical random access channel (PRACH), and/or the like); and/or CSI-report configuration information (e.g., associated with the first RS resource set). The configuration information may include a RS request (RSR) configuration information. RSR configuration may include content to transmit (e.g., indication of which OD-RS to activate, how many to activate, etc.), a method of transmission (e.g., SR, PRACH, and/or UL-WUS, etc.) and/or one or more resources for transmission (e.g., which time and/or frequency resource(s). The WTRU may send a RSR request in accordance with the RSR configuration information. In response to the RSR request, for example, the WTRU may receive the (e.g., first) indication indicating activation of the at least one RS resource. The at least one RS resource may be activated based on the (e.g., first) indication. The configuration may include an indication of a plurality of periodicities. The configuration information may include one or more thresholds associated with a beam-quality based determination, a time-based determination, and/or a prediction quality-based determination.

The WTRU may receive a (e.g., first) indication that at least one RS resource of the first RS resource set has been activated. Activation of the at least one RS resource may include an increase in periodicity of transmission of the at least one RS resource. The first RS resource set may be and/or include one or more on-demand RS resources. For example, the whole set and/or a subset of RSs within the first RS resource set may be on-demand RS(s). The WTRU may activate the one or more on-demand RS resources to activate the one RS resources. The WTRU may receive an indication indicating activation and/or increase in transmission periodicity (e.g., based on WTRU transmission of CSI-report) and/or one or more requests (e.g., triggered based on beam failure detection) to activate and/or increase transmission periodicity of RSs associated with the (e.g., first) RS resource set by transmitting an RSR. The WTRU may receive an indication confirming activation and/or increase in transmission periodicity of RSs associated with the (e.g., first) RS resource set based on, for example the transmission of RSR. To activate the at least one RS resource, for example, the WTRU may increase a periodicity from a first periodicity of the plurality of periodicities to a second periodicity of the plurality of periodicities or to a third periodicity of the plurality of periodicities. The WTRU may activate and/or deactivate the at least one RS resource based on the one or more thresholds associated with the beam-quality based determination, the time-based determination, and/or the prediction quality-based determination.

The WTRU may measure activated RSs associated with the first RS resource set. For example, the WTRU may determine a measurement value associated with each RS resource of the activated at least one RS resource. The WTRU may determine a subset of RS resources based on the measurement value based on when and/or whether the measurement value is greater than a threshold of the one or more thresholds. The WTRU may send a message (e.g., a BFR message, a CSI message) to a base station based on the configuration information (e.g., BFR configuration information, CSI configuration information). The message (e.g., BFR message, CSI message) may include an indication of one or more measurements performed on the activated at least one RS resource. The indication of the one or more measurements may include an indication of the subset of RS resources. The message (e.g., BFR message, CSI message) may be sent using the second RS resource set. The WTRU may perform one or more of the following, for example, based on the measurement(s). The WTRU may transmit a beam failure recover request (e.g., via medium access control (MAC) control element (CE) BFR and/or PRACH). The WTRU may transmit a CSI report.

The WTRU may receive a (e.g., second) indication that the at least one RS resource has been deactivated. Deactivation of the at least one RS resource may include a decrease in periodicity of transmission of the at least one RS resource. The WTRU may receive the (e.g., second) indication to deactivate the at least one RS resource and/or receive a BFR response message. For example, reception of BFR response may indicate (e.g., imply) a successfully completed BFR procedure (e.g., the reception of BFR response may be and/or include indication). Additionally or alternatively, the BFR response's payload (e.g., msg2) may include an indication of one or more RS(s) to deactivate (e.g., via MAC-CE and/or DCI). The at least one RS resource may be deactivated based on the second indication and/or the BFR response message. The WTRU may deactivate the one or more on-demand RS resources to deactivate the at least one RS resource. The WTRU may receive an indication indicating deactivation and/or a decrease in transmission periodicity and/or may determine deactivated state and/or decreased transmission periodicity of the RSs associated with the (e.g., first) RS resource based on one or more of the following. The WTRU may receive an indication indicating deactivation and/or a decrease in transmission periodicity and/or may determine deactivated state and/or decreased transmission periodicity of the RSs associated with the (e.g., first) RS resource based on transmission of a BFR request, reception of BFR response (e.g., msg2), and/or transmission of CSI-report (e.g., LTM CSI report, aperiodic CSI report, AIML CSI report, etc.). The WTRU may receive an indication indicating deactivation and/or a decrease in transmission periodicity and/or may determine deactivated state and/or decreased transmission periodicity of the RSs associated with the (e.g., first) RS resource based on time-based deactivation (e.g., X symbols, slots/msec based on activation of RSs). To deactivate the at least one RS resource, the WTRU may, for example, decrease the periodicity from the second periodicity or the third periodicity to the first periodicity or to a fourth periodicity of the plurality of periodicities. The WTRU may activate and/or deactivate the at least one RS resource based on the one or more thresholds associated with the beam-quality based determination, the time-based determination, and/or the prediction quality-based determination. Activation of an RS may refer to turning on transmission of RS (e.g., from WTRU perspective). For example, a WTRU (e.g., and/or WTRU's processor) may be configured to enable measurement of that RS and/or increase periodicity of RS. Deactivation of an RS may refer to turning off transmission of RS (e.g., from WTRU perspective). For example, a WTRU (e.g., and/or WTRU's processor) may be configured to disable measurement of that RS and/or decrease periodicity of RS.

1. A wireless transmit/receive unit (WTRU) comprising:
a processor configured to:
receive configuration information, wherein the configuration information comprises beam failure recovery (BFR) configuration information, a first reference signal (RS) resource set, and a second RS resource set;
receive a first indication that at least one RS resource of the first RS resource set has been activated;
send a BFR message to a base station based on the BFR configuration information, wherein the BFR message comprises an indication of one or more measurements performed on the activated at least one RS resource, and wherein the BFR message is sent using at least one RS resource of the second RS resource set; and
receive a second indication that the at least one RS resource has been deactivated.

2. The WTRU of claim 1, wherein activation of the at least one RS resource comprises an increase in periodicity of transmission of the at least one RS resource.

3. The WTRU of claim 1, wherein deactivation of the at least one RS resource comprises a decrease in periodicity of transmission of the at least one RS resource.

4. The WTRU of claim 1, wherein the first RS resource set comprises one or more on-demand RS resources; and
wherein the processor is configured to:
activate the one or more on-demand RS resources to activate the at least one RS resource, and wherein the processor is configured to deactivate the one or more on-demand RS resources to deactivate the at least one RS resource, wherein the first RS resource set is associated with one or more of a BFR configuration, a lower layer triggered mobility (LTM) configuration, a channel state information (CSI)-report configuration, or one or more artificial intelligence machine learning (AIML) sets.

5. The WTRU of claim 1, wherein the configuration information comprises RS request (RSR) configuration information; and
wherein the processor is configured to:
send a RSR request in accordance with the RSR configuration information; and
in response to the RSR request, receive the first indication indicating activation of the at least one RS resource, wherein the at least one RS resource is activated based on the first indication.

6. The WTRU of claim 5, wherein the processor is configured to:
receive the second indication to deactivate the at least one RS resource or receive a BFR response message, wherein the at least one RS resource is deactivated based on the second indication or the BFR response message.

7. The WTRU of claim 6, wherein the configuration information comprises an indication of a plurality of periodicities; and
wherein, to activate the at least one RS resource, the processor is configured to increase a periodicity from a first periodicity of the plurality of periodicities to a second periodicity of the plurality of periodicities or to a third periodicity of the plurality of periodicities.

8. The WTRU of claim 6, wherein, to deactivate the at least one RS resource, the processor is configured to decrease the periodicity from the second periodicity or the third periodicity to the first periodicity or to a fourth periodicity of the plurality of periodicities.

9. The WTRU of claim 1, wherein the configuration information comprises one or more thresholds associated with a beam quality-based determination, a time-based determination, or a prediction quality-based determination; and
wherein the processor is configured to activate or deactivate the at least one RS resource based on the one or more thresholds associated with the beam quality-based determination, the time-based determination, or the prediction quality-based determination.

10. The WTRU of claim 9, wherein the processor is configured to:
determine a measurement value associated with each RS resource of the activated at least one RS resource; and
determine a subset of RS resources based on whether the measurement value is greater than a threshold of the one or more thresholds, and wherein the indication of the one or measurements comprises an indication of the subset of RS resources.

11. A method performed by a wireless transmit/receive unit (WTRU), the method comprising:
receiving configuration information, wherein the configuration information comprises beam failure recovery (BFR) configuration information, a first reference signal (RS) resource set, and a second RS resource set;
receiving a first indication that at least one RS resource of the first RS resource set has been activated;
sending a BFR message to a base station based on the BFR configuration information, wherein the BFR message comprises an indication of one or more measurements performed on the activated at least one RS resource, and wherein the BFR message is sent using at least one RS resource of the second RS resource set; and
receiving a second indication that the at least one RS resource has been deactivated based on the configuration information.

12. The method of claim 11, wherein activation of the at least one RS resource comprises an increase in periodicity of transmission of the at least one RS resource.

13. The method of claim 11, wherein deactivation of the at least one RS resource comprises a decrease in periodicity of transmission of the at least one RS resource.

14. The method of claim 11, wherein the first RS resource set comprises one or more on-demand RS resources; and
wherein activating the at least one RS resource comprising activating the one or more on-demand RS resources to activate the at least one RS resource, and wherein deactivating the at least one RS resource comprising deactivating the one or more on-demand RS resources, and wherein the first RS resource set is associated with one or more of a BFR configuration, a lower layer triggered mobility (LTM) configuration, a channel state information (CSI)-report configuration, or one or more artificial intelligence machine learning (AIML) sets.

15. The method of claim 11, wherein the configuration information comprises RS request (RSR) configuration information; and
wherein the method further comprising:
sending a RSR request in accordance with the RSR configuration information; and
in response to the RSR request, receiving a first indication indicating activation of the at least one RS resource, wherein the at least one RS resource is activated based on the first indication.

16. The method of claim 15, further comprising:
receiving a second indication to deactivate the at least one RS resource or receive a BFR response message, wherein the at least one RS resource is deactivated based on the second indication or the BFR response message.

17. The method of claim 16, wherein the configuration information comprises an indication of a plurality of periodicities; and
wherein, to activate the at least one RS resource, the method further comprising increasing a periodicity from a first periodicity of the plurality of periodicities to a second periodicity of the plurality of periodicities or to a third periodicity of the plurality of periodicities.

18. The method of claim 16, wherein, to deactivate the at least one RS resource, the method further comprising decreasing the periodicity from the second periodicity or the third periodicity to the first periodicity or to a fourth periodicity of the plurality of periodicities.

19. The WTRU of claim 11, wherein the configuration information comprises one or more thresholds associated with a beam quality-based determination, a time-based determination, or a prediction quality-based determination,
wherein the at least one RS resource is activated or deactivated based on the one or more thresholds associated with the beam quality-based determination, the time-based determination, or the prediction quality-based determination;
wherein the method further comprising:
determining a measurement value associated with each RS resource of the activated at least one RS resource; and
determining a subset of RS resources based on the measurement value when the measurement value is greater than a threshold of the one or more thresholds, and wherein the indication of the one or measurements comprises an indication of the subset of RS resources.

20. A wireless transmit/receive unit (WTRU) comprising:
a processor configured to:
receive configuration information, wherein the configuration information comprises channel state information (CSI) configuration information, a first reference signal (RS) resource set, and a second RS resource set;
receive a first indication that at least one RS resource of the first RS resource set has been activated;
send a CSI message to a base station based on the CSI configuration information, wherein the CSI message comprises an indication of one or more measurements performed on the activated at least one RS resource, and wherein the CSI message is sent using at least on RS resource of the second RS resource set; and
receive a second indication that the at least one RS resource has been deactivated.
